(19) United States
(12) Patent Application Publication
(10) Pub. No.: US 2014/0325277 A1
(43) Pub. Date: Oct. 30, 2014

(54) INFORMATION PROCESSING TECHNIQUE FOR MANAGING COMPUTER SYSTEM

(71) Applicant: FUJITSU LIMITED, Kawasaki-shi (JP)

(72) Inventors: Masataka SONODA, Kawasaki (JP); Yasuhide MATSUMOTO, Kawasaki (JP)

(73) Assignee: FUJITSU LIMITED, Kawasaki-shi (JP)

(21) Appl. No.: 14/325,068

(22) Filed: Jul. 7, 2014

Related U.S. Application Data
(63) Continuation of application No. PCT/JP2012/051796, filed on Jan. 27, 2012.

(51) Int. Cl. G06F 11/07

(52) U.S. Cl. CPC G06F 11/079
USPC 714/27

(57) ABSTRACT

A present method includes: identifying a component item that satisfies a predetermined condition concerning an indicator value for an influenced range within a system, from among plural component items included in the system, by using data regarding the plural component items and relationships among the plural component items; extracting component items included in a predetermined range from the identified component item, based on the data; and generating one or plural failure patterns, each of which includes one or plural sets of one component item of the extracted component items and a failure type corresponding to the one component item, by using data including, for each component item type, one or plural failure types.

### CROSS-REFERENCE TO RELATED APPLICATIONS

This application is a continuing application, filed under 35 U.S.C. section 111(a), of International Application PCT/JP2012/051796, filed on Jan. 27, 2012, the entire contents of which are incorporated herein by reference.

### FIELD

This technique relates to a management technique of a computer system.

### BACKGROUND

Because of the development of the cloud computing or the like, the computer system becomes larger, and a failure of a part of devices within the system and/or an operation mistake such as a setting mistake influence broadly.

Conventionally, as for countermeasures against troubles, there is a method in which a scenario-based test is performed in advance. More specifically, a scenario is created by assuming past experience and/or utilization, occurrences of the troubles and the like, and a test is performed along the scenario. However, because the scenario is created based on the initial assumption, there is a problem that a case that have a large risk and is beyond expectation cannot be covered. Especially, there are various kinds of causes for the troubles, and the situation beyond expectation cannot be avoided. Furthermore, the system often falls into the situation beyond expectation when the large-scale trouble occurs. In other words, a latent risk that was not mentioned at the design becomes an issue when any condition is satisfied by another trouble, and troubles sequentially occur and become large-scale. On the other hand, in case of the situation within the expectation, it is possible to prepare the countermeasure and settle the trouble before the influence extends.

It is preferable that the situation beyond expectation is eliminated in order to avoid the aforementioned large-scale trouble, however, the manual assumption is difficult. Therefore, a method for predicting a range of the influence by the simulation is often employed. More specifically, by performing simulation of the situation of the system step-by-step while changing a failure pattern, the range of the influence of the trouble is predicted for each failure pattern. However, the number of failure patterns for which the simulation should be performed becomes very huge for the large-scale system.

It is assumed that the failure pattern represents what component item within the system breaks and how to break, “i” represents the number of component items, and “j” represents an average value of the number of kinds of failures in each component item. Then, the number of failure patterns P is represented as follows:

P=i*j+ᵢC₂*j*j

For example, it is assumed that a cloud center includes 8 zones, and some hundreds physical machines and some thousands virtual machines are included in one zone. In such a case, in case of assuming j=5, there are about 0.2 million patterns only for a case in which only one portion breaks, and there are patterns more than 10 billion for a case in which two portions break. Thus, it is not realistic that all patterns are simulated.
Patent Document 1: Japanese Laid-open Patent Publication No. 2004-312224
Patent Document 2: Japanese Laid-open Patent Publication No. 2011-180805
Patent Document 3: Japanese Laid-open Patent Publication No. 4-310160
Patent Document 4: Japanese Laid-open Patent Publication No. 11-259331
Patent Document 5: Japanese Laid-open Patent Publication No. 2011-155508

### SUMMARY

Therefore, there is no conventional technique for efficiently identifying failure patterns that have large influence.

An information processing method relating to this technique includes: (A) identifying a component item that satisfies a predetermined condition concerning an indicator value for an influenced range within a system, from among plural component items included in the system, by using data regarding the plural component items and relationships among the plural component items; (B) extracting component items included in a predetermined range from the identified component item, based on the data; and (C) generating one or plural failure patterns, each of which includes one or plural sets of one component item of the extracted component items and a failure type corresponding to the one component item, by using data including, for each component item type, one or plural failure types.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting a system configuration example;

FIG. 2 is a diagram depicting an example of connection relationships between component items;

FIG. 3 is a diagram depicting an example of data stored in a system configuration data storage unit;

FIG. 4 is a diagram depicting an example of data stored in the system configuration data storage unit;

FIG. 5 is a diagram depicting an example of data stored in the system configuration data storage unit;

FIG. 6 is a diagram depicting an example of calling relationships between component items;

FIG. 7 is a diagram depicting an example of data stored in the system configuration data storage unit;

FIG. 8 is a diagram depicting an example of data stored in the system configuration data storage unit;

FIG. 9 is a diagram depicting a processing flow relating to a first embodiment;

FIG. 10 is a diagram depicting an example of a system in which occurrences of troubles are assumed;

FIG. 11 is a diagram depicting a processing flow of a processing for identifying an aggregation point;

FIG. 12 is a diagram depicting a physical configuration example of a system;

FIG. 13 is a diagram to explain the number of subordinate items;

FIG. 14 is a diagram depicting examples of calculation results of the number of subordinate items and the number of items that directly or indirectly call an item to be processed;

FIG. 15 is a diagram to explain the number of items that directly or indirectly call an item to be processed;

FIG. 16 is a diagram depicting an example of data stored in an aggregation point storage unit;

FIG. 17 is a diagram depicting a processing flow of a processing for extracting a failure part candidate;

FIG. 18 is a diagram to explain the processing for extracting the failure part candidate;

FIG. 19 is a diagram to explain the processing for extracting the failure part candidate;

FIG. 20 is a diagram depicting an example of data stored in a failure part candidate list storage unit;

FIG. 21 is a diagram depicting a processing flow of a processing for generating a failure pattern;

FIG. 22 is a diagram depicting an example of data stored in a failure type list storage unit;

FIG. 23 is a diagram to explain the processing for generating the failure pattern;

FIG. 24 is a diagram depicting an example of data stored in a failure pattern list storage unit;

FIG. 25 is a diagram depicting an example of a state transition model;

FIG. 26 is a diagram depicting an example of a state transition model of a switch;

FIG. 27 is a diagram depicting an example of a state transition model of a physical machine;

FIG. 28 is a diagram depicting an example of a state transition model of a main virtual machine;

FIG. 29 is a diagram depicting an example of a state transition model of a copy virtual machine;

FIG. 30 is a diagram depicting an example of a state transition model of a manager;

FIG. 31 is a diagram depicting an initial state in a simulation example;

FIG. 32 is a diagram depicting a state at a first step in the simulation example;

FIG. 33 is a diagram depicting a state at a second step in the simulation example;

FIG. 34 is a diagram depicting a state at a third step in the simulation example;

FIG. 35 is a diagram depicting a state at a fourth step in the simulation example;

FIG. 36 is a diagram depicting a state at a fifth step in the simulation example;

FIG. 37 is a diagram depicting an example of data stored in a simulation result storage unit;

FIG. 38 is a diagram depicting an example of a processing result;

FIG. 39 is a diagram depicting a processing flow relating to a second embodiment;

FIG. 40A is a diagram depicting a range in case of n=1;

FIG. 40B is a diagram depicting a simulation result in case of n=1;

FIG. 41A is a diagram depicting a range in case of n=2;

FIG. 41B is a diagram depicting a simulation result in case of n=2;

FIG. 42 is a diagram depicting change of the maximum number of damaged items; and

FIG. 43 is a functional block diagram of a computer.

### DESCRIPTION OF EMBODIMENTS

### Embodiment 1

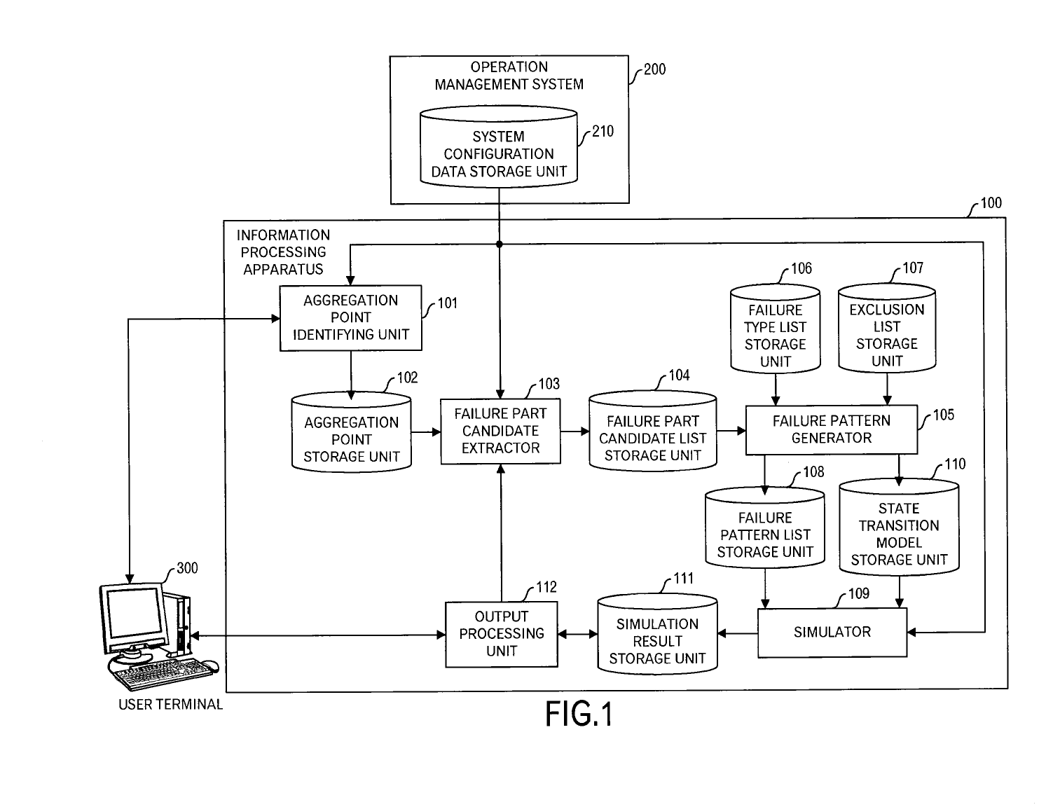

FIG. 1 illustrates a system configuration relating to an embodiment of this technique. This system includes an information processing apparatus 100, an operation management system 200 and one or plural user terminals 300. These apparatuses are connected with a network.

The operation management system 200 is a system that has already been constructed for operation management of a system in which occurrences of the troubles are assumed, and includes a system configuration data storage unit 210 that stores data of component items for the system in which the occurrences of the troubles are assumed.

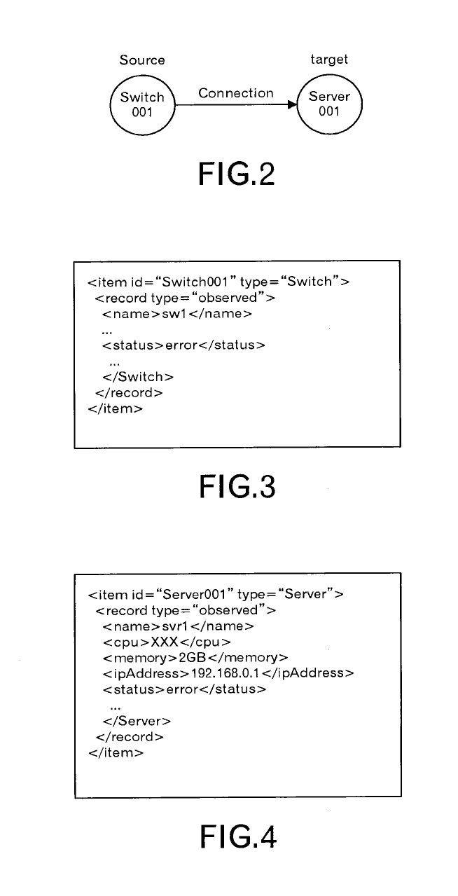

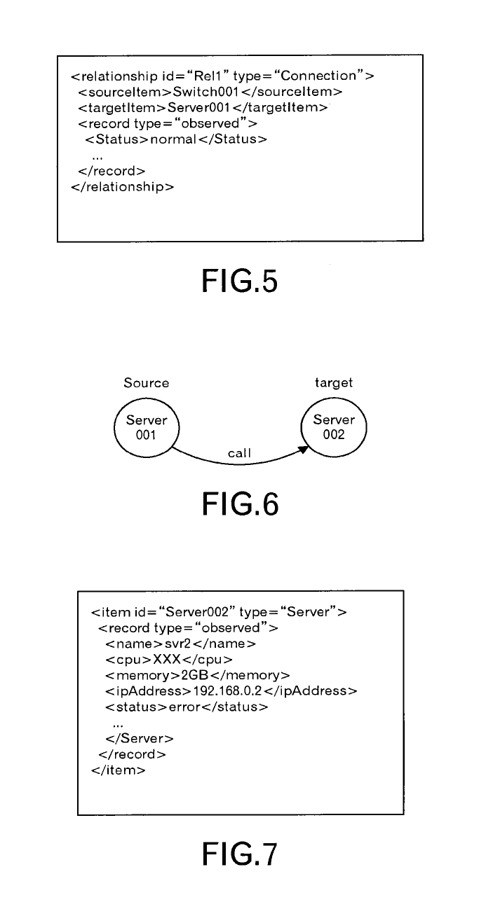

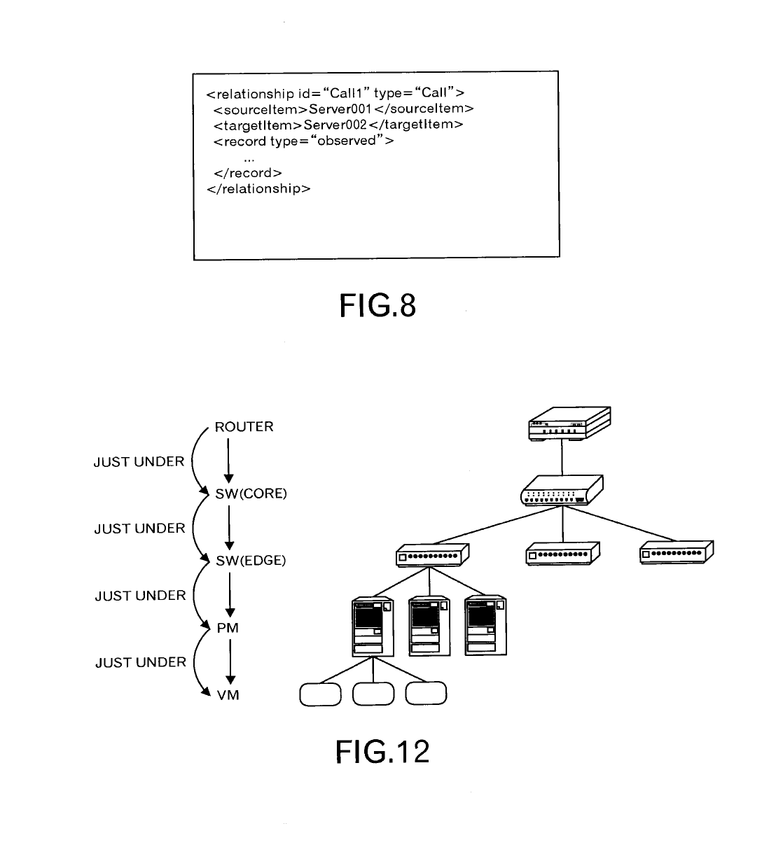

The system configuration data storage unit 210 stores data of component items within the system, data of connection relationships between component items, and calling relationships between component items. For example, when a switch Switch001 is connected with a server Server001 as illustrated in FIG. 2, data as illustrated in FIGS. 3 to 5 is stored in the system configuration data storage unit 210. FIG. 3 represents data of the switch Switch001 that is a source of the connection, and a type, various attributes, a state and the like of the switch Switch001 are registered. Moreover, FIG. 4 represents data of the server Server001 that is a target of the connection, and a type, various attributes, a state and the like of the server Server001 are registered. Then, FIG. 5 represents the connection relationship between the switch Switch001 and the server Server001, and a type (Connection), a component item that is a source, a component item that is a target, a connection state and the like of the relationship are registered. Moreover, when a server Server002 are called from the server Server001 as illustrated in FIG. 6, data as illustrated in FIG. 4, and FIGS. 7 and 8 are stored in the system configuration data storage unit 210. FIG. 7 represents data of the server Server002 that is a calling destination, and similarly to FIG. 4, a type, various attributes, a state and the like of the server Server002 are registered. FIG. 8 illustrates a calling relationship from the server Serve001 to the server Server002, and a type (Call), a component item that is a source, a component item that is a target and the like of the relationship are registered.

The examples in FIGS. 3 to 8 are examples described by eXtensible Markup Language (XML), however, the component items and their relationships may be described by other methods.

The information processing apparatus 100 has an aggregation point identifying unit 101, an aggregation point storage unit 102, a failure part candidate extractor 103, a failure part candidate list storage unit 104, a failure pattern generator 105, a failure type list storage unit 106, an exclusion list storage unit 107, a failure pattern list storage unit 108, a simulator 109, a state transition model storage unit 110, a simulation result storage unit 111 and an output processing unit 112.

The aggregation point identifying unit 101 uses data stored in the system configuration data storage unit 210 to identify an aggregation point in the system in which the occurrences of the troubles are assumed, and stores data of the identified aggregation point into the aggregation point storage unit 102. The failure part candidate extractor 103 extracts a failure part candidate from the system configuration data storage unit 210 based on data stored in the aggregation point storage unit 102, and stores extracted results into the failure part candidate list storage unit 104. The failure pattern generator 105 generates a failure pattern by using data stored in the failure part candidate list storage unit 104 and the failure type list storage unit 106, and stores data of the generated failure pattern into the failure pattern list storage unit 108. At this time, the failure pattern generator 105 deletes a failure pattern to be deleted from the failure pattern list storage unit 108 based on data stored in the exclusion list storage unit 107.

The simulator 109 performs, for each failure pattern stored in the failure pattern list storage unit 108, simulation for state transitions of the component items stored in the system configuration data storage unit 210, according to the state transition model stored in the state transition model storage unit 110, while assuming that the failure pattern occurs, and stores the simulation results into the simulation result storage unit 111. The output processing unit 112 generates output data from data stored in the simulation result storage unit 111 in response to a request from the user terminal 300, for example, and outputs the generated output data to the user terminal 300.

For example, the user terminal 300 is a personal computer operated by an operation administrator, and instructs the aggregation point identifying unit 101 of the information processing apparatus 100 or the like, to start the processing and requests the output processing unit 112 to output the processing result, receives the processing result from the output processing unit 112 and displays the processing result on a display apparatus.

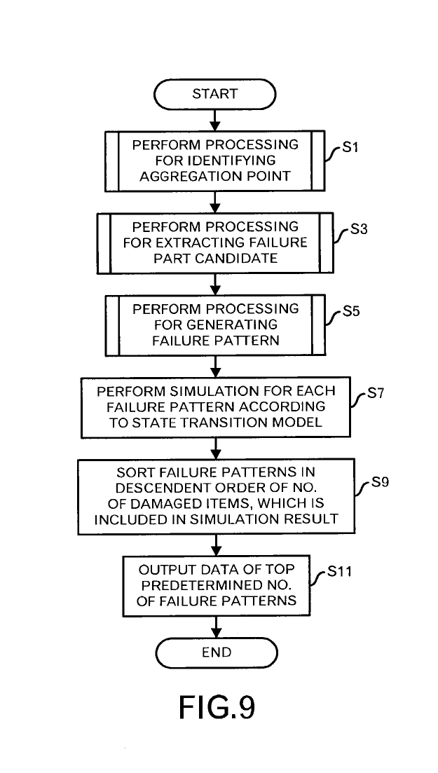

Next, processing contents of the information processing apparatus 100 will be explained by using FIGS. 9 to 38.

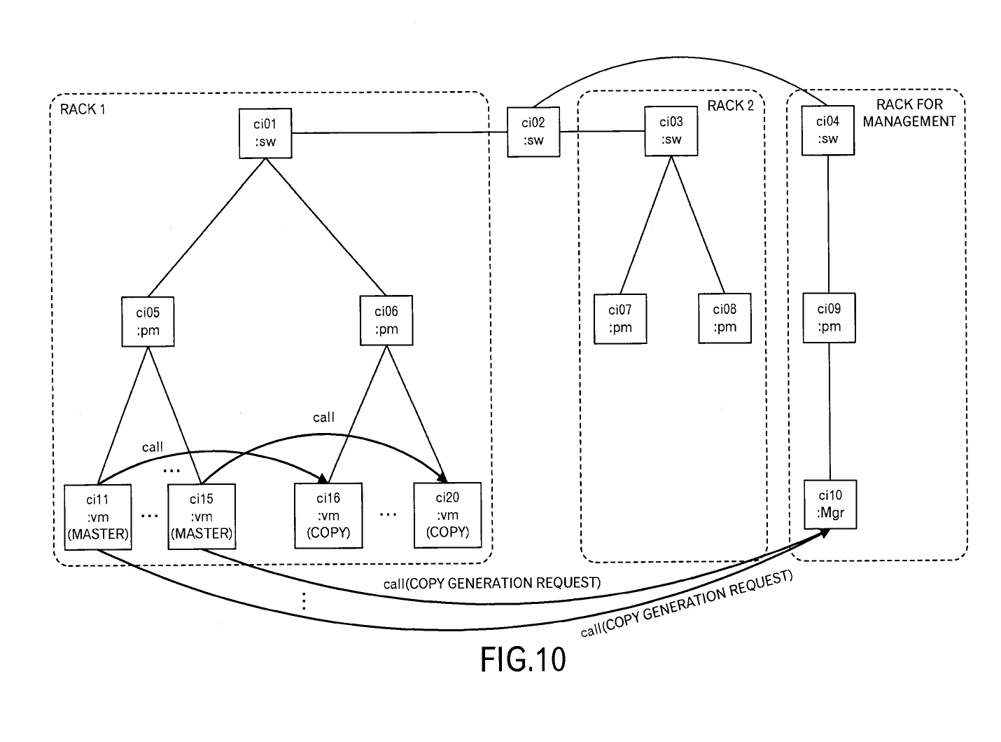

Firstly, the aggregation point identifying unit 101 performs a processing for identifying an aggregation point (FIG. 9: step S1). This processing for identifying the aggregation point will be explained by using FIGS. 10 to 16.

In this embodiment, an explanation will be made using a system, for example, illustrated in FIG. 10 as the system in which the occurrences of the troubles are assumed. This system includes two racks (racks 1 and 2) for the service and one rack for the management. These racks are connected through a switch ci02. In the rack 1, physical machines (pm) ci05 and ci06 are connected with the switch ci01, which is connected to the switch ci02, and virtual machines (vm) ci11 to ci15 are provided under the physical machine ci05, and virtual machines ci16 to ci20 are provided under the physical machine ci06. In the rack 2, physical machines ci07 and ci08 are connected with a switch ci03, which is connected to the switch ci02. There is no virtual machine under the physical machines ci07 and ci08. In the rack for the management, a physical machine ci09 is connected to a switch ci04, which is connected with the switch ci02, and a component item ci10, which is a manager (Mgr), is provided in this physical machine ci09. Such respective component items and connection relationships between those component items are defined in the system configuration data storage unit 210.

In this system, the virtual machines ci11 to ci15 are masters, and the virtual machines ci16 to ci20 are their copies. The virtual machines ci11 to ci15, which are masters, respectively confirm existences of their copies, for example, periodically. This is defined in the system configuration data storage unit 210 as a calling relationship (Call) from the virtual machine ci11 to the virtual machine ci16. As for the virtual machines ci12 to ci15, the same data is defined. Moreover, when the existence of its own copy becomes unknown, the virtual machines ci11 to ci15, which are masters, send a request (Call), in other words, a copy generation request, to the manager Mgr in order to generate its new copies of the virtual machines ci11 to ci15. This is defined as a calling relationship from the virtual machines ci11 to ci15, which are masters, to the manager Mgr.

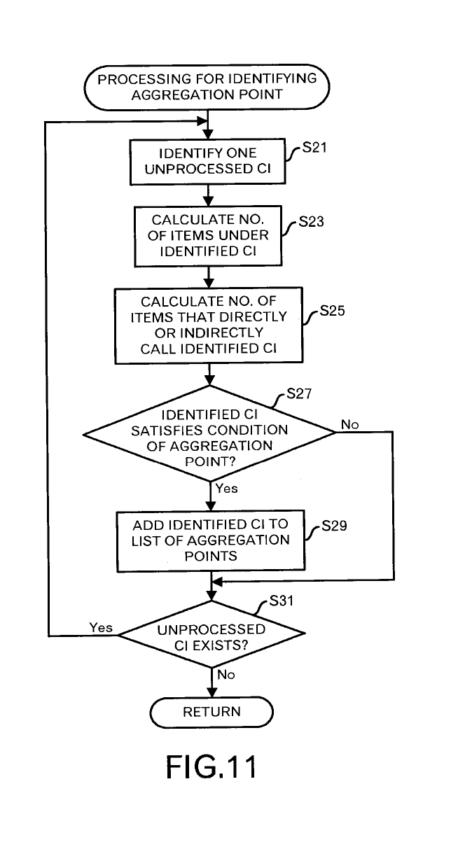

Firstly, the aggregation point identifying unit 101 identifies one unprocessed Component Item (CI) in the system configuration data storage unit 210 (FIG. 11: step S21). As will be explained later, when a component item is selected from component items that correspond to the virtual machines, it is efficient. The aggregation point identifying unit 101 calculates the number of items under the identified component item, and stores the calculated number of items into a storage device such as a main memory (step S23).

In this embodiment, an item type of the identified component item is identified, and the number of subordinate items is calculated according to the item type. The item types of the component items include a router, a switch (core), a switch (edge), a physical machine and a virtual machine. Typically, the physical configuration of the system is as illustrated in FIG. 12, and includes a top-level router, switches (core) that are arranged under the router and are almost connected to the subordinate switch, switches (edge) other than the core switches, physical machines (PM) that are connected to any switch, and virtual machines (VM) that are activated on any physical machine. As for the router, switches, physical machines and virtual machines, the item type is positively defined, therefore, is identified based on the definition. The edge switches and core switches are distinguished according to the item type of the component item that is the connection destination as described above.

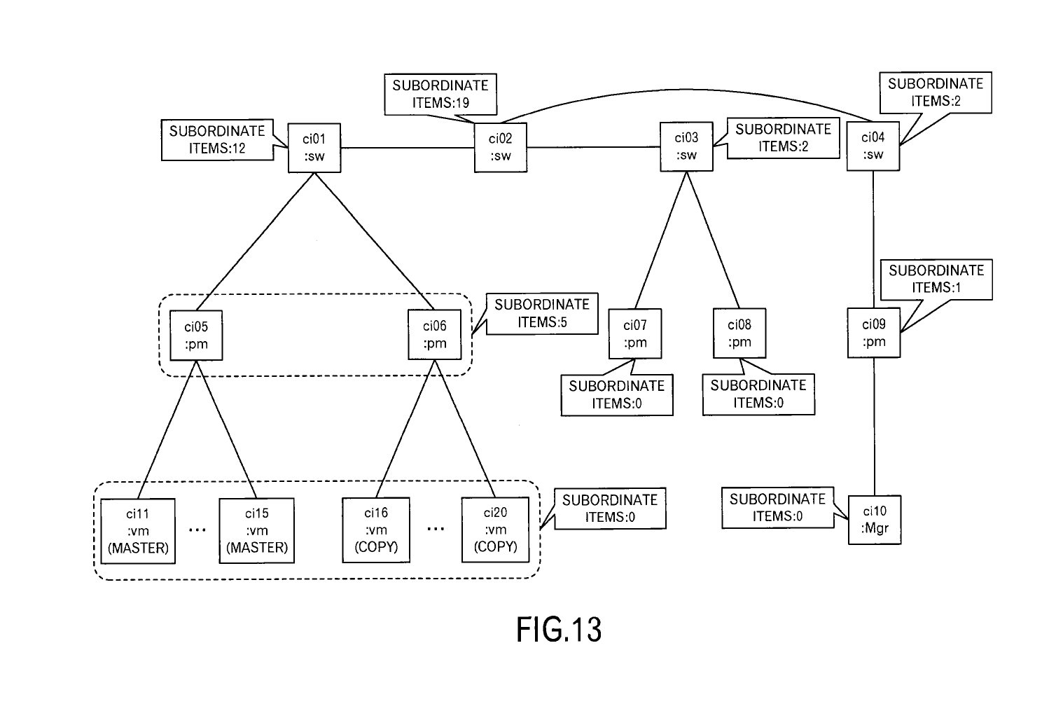

Then, in case of the core switch, the number of subordinate items of the core switch is calculated by a total sum of the number of edge switches just under itself and the number of items under the edge switches just under itself. As illustrated in FIG. 13, in the system illustrated in FIG. 10, the switch ci02 is the core switch because the connection destinations are only switches. In such a case of the switch ci02, the number of subordinate items is calculated by a total sum “19” of the number of switches ci01, ci03 and ci04 just under itself “3” and a sum of the numbers of items under them “16 (=12+2+2)”.

Moreover, in case of the edge switch, the number of items under the edge switch is calculated by a total sum of the number of physical machines just under itself and the number of items under them. The switch ci01 is connected to two physical machines ci05 and ci06, and is determined as being the edge switch. Then, the number of subordinate items is calculated by a total sum “12” of the number of physical machines ci05 and ci06 “2” and a sum of the numbers of items under these physical machines ci05 and ci06 “10 (=5+5)”. The switch ci03 is connected to two physical machines ci07 and ci08, and is determined as being the edge switch. Then, the number of subordinate items is calculated by a total sum “2” of the number of physical machines ci07 and ci08 “2” and a sum of the numbers of items under these physical machines ci07 and ci08 “0”. The switch ci04 is connected to the physical machine ci09, and is determined as being the edge switch. Then, the number of subordinate items is calculated by a total sum “2” of the number of physical machines ci09 “1” and a sum of the numbers of items under this physical machine ci09 “1”.

Furthermore, in case of the physical machine, the number of virtual machines just under itself is the number of subordinate items of the physical machine. In case of the physical machines ci05 and ci06, the number of virtual machines just under itself is “5”, so the number of subordinate items is “5”. In case of the physical machines ci07 and ci08, the number of virtual machines just under itself is “0”, so the number of subordinate items is “0”. In case of the physical machine ci09, the number of the virtual machines just under itself is “1”, so the number of subordinate items is “1”. In case of the virtual machines, the number of subordinate items is identified as being “0”.

Moreover, the aggregation point identifying unit 101 calculates the number of items that directly or indirectly call the identified component item, and stores the calculated number of items into the storage device such as the main memory (step S25). The number of items that directly or indirectly call the identified component item is calculated as a total sum of the number of calling relationships whose target is the identified component item and the number of items that directly or indirectly call the source of that calling relationship. In other words, the source of the calling relationship is reversely traced and the total sum of the numbers of calling relationships until the trace cannot be performed is the number of items that directly or indirectly call the identified component item. In the example of FIG. 10, in case of the manager Mgr, 5 calling relationships whose sources are the virtual machines ci11 to ci15 are registered, and the number of items that directly or indirectly call the identified component item is “5”. On other hand, in case of the virtual machines ci16 to ci20, which are copies, they are called by its own master. Therefore, one calling relationship whose source is the master of the virtual machine is respectively registered. Therefore, as for these virtual machines ci16 to ci20, the number of items that directly or indirectly call that virtual machine is “1”.

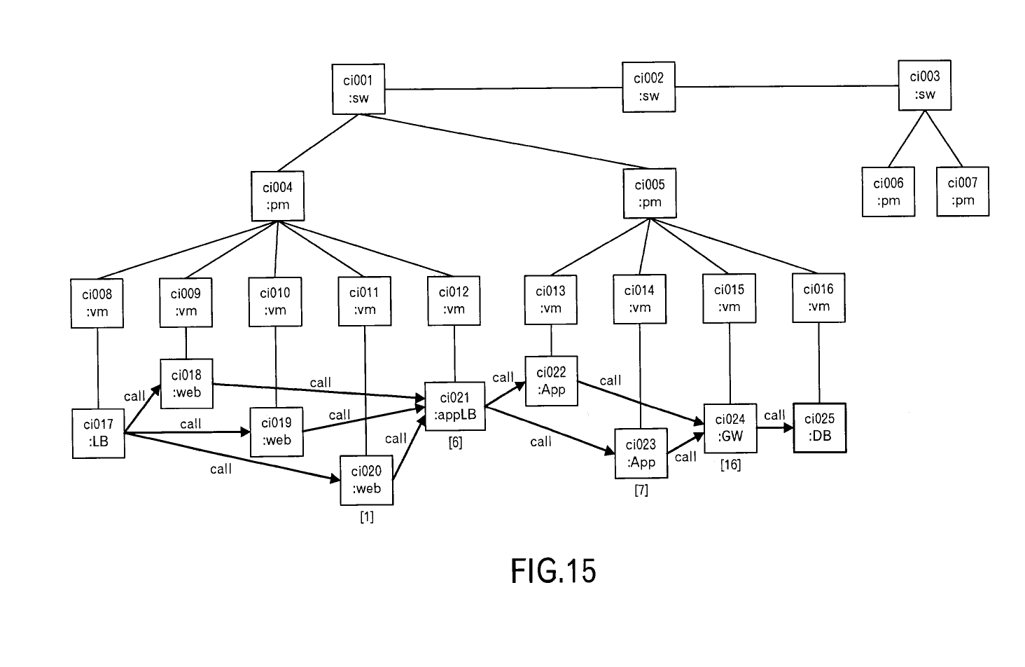

On the other hand, as another example, it is assumed that, in a system as illustrated in FIG. 15, a load balancer (LB) ci017, web servers (Web) ci018 to ci020, a load balance (AppLB) ci021 for application servers, application servers (App) ci022 and ci023, a gateway (GW) ci024 and a DB server (DB) ci025 are provided. In such a case, as illustrated in FIG. 15, the calling relationship from the load balancer ci017 is connected to the web servers, load balancer for the application servers, application servers, gateway and DB server, sequentially. In such a case, the number of items that directly or indirectly call each web server is “1”, and the number of items that directly or indirectly call the load balancer for the application servers is “6”. Moreover, the number of items that directly or indirectly call each application server is “7”, and the number of items that directly or indirectly call the gateway is “16”. As a result, the number of items that directly or indirectly call the DB server is “17”.

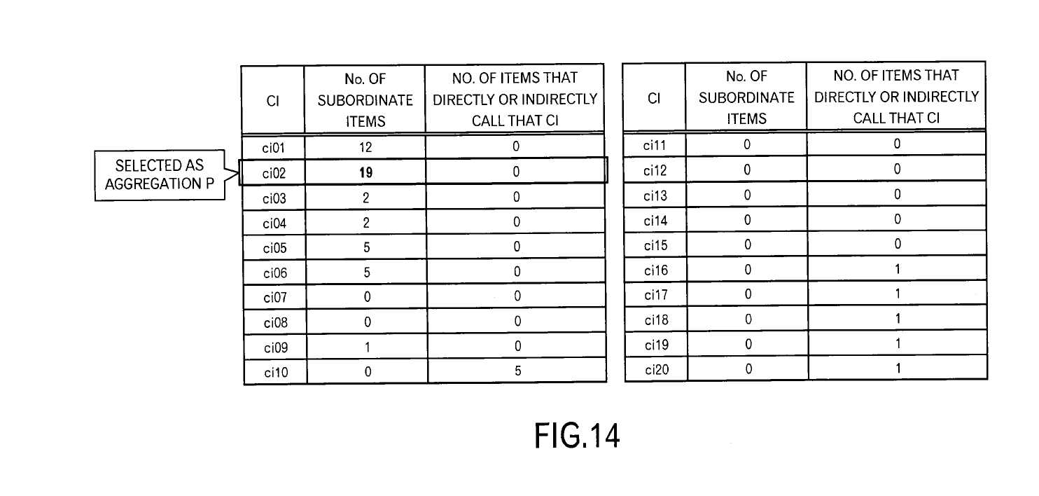

Then, for example, the calculation results as illustrated in FIG. 14 are obtained. In an example of FIG. 14, as for each component item (CI), the number of subordinate items and the number of items that directly or indirectly call the item to be processed are registered. Thus, indicator values for the range that is influenced in case where this component item within this system becomes inoperable are registered.

Then, the aggregation point identifying unit 101 determines whether or not the identified component item satisfies a condition of an aggregation point (also noted as “aggregation P”) (step S27). For example, it is determined whether or not the number of subordinate items is equal to or greater than “16” or the number of items that directly or indirectly call the identified component item is equal to or greater than “6”. Whether or not the identified component item is the aggregation point is determined based on whether or not an evaluation value that is calculated by adding the number of subordinate items and the number of items that directly or indirectly call the identified component item with weights is equal to or greater than a threshold. In the example of FIG. 14, it is determined that the component item ci02 depicted by a thick frame satisfies the condition of the aggregation point.

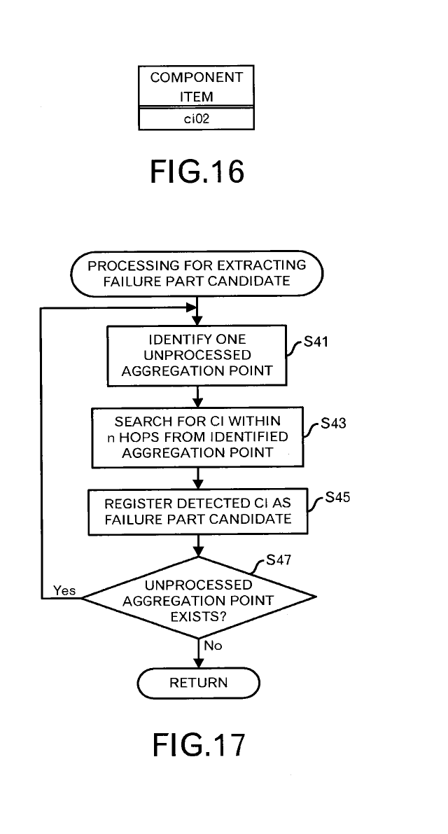

When the condition of the aggregation point is not satisfied, the processing shifts to step S31. On the other hand, when the condition of the aggregation point is satisfied, the aggregation point identifying unit 101 adds the identified component item to the aggregation point list, and stores its data into the aggregation point storage unit 102 (step S29). The aggregation point storage unit 102 stores data as illustrated in FIG. 16, for example. As illustrated in FIG. 16, a list in which an identifier of the component item identified as the aggregation point is registered is stored. When a criterion for the structural aggregation point, which is different from a criterion for the behavior, is used, the failure part candidate may be extracted based on a different criterion also when extracting the failure part candidate. Therefore, in addition to the identifier of the component item, the distinction of the structure and behavior may be set in the aggregation point storage unit 102.

As described above, the aggregation point is the component item that is associated with a lot of other component items in the system. Then, there are a structural aggregation point that is identified because the component item has a lot of subordinate items as described above and a behavioral aggregation point that is identified because of the number of items that directly or indirectly call the item to be processed, which means that the specific item is directly or indirectly called from a lot of component items. This is because the possibility is high that the influence range expands in short time, when the aggregation point is influenced by the failure, and it is important in view of the countermeasure that the failure that influences the aggregation point is discovered. Especially, the failure that influences the aggregation point in the early stage is a failure whose exigency is high, and it is much effective that such a failure whose exigency is high can be treated. Therefore, in this embodiment, the failure that influences the aggregation point in the early stage is searched for.

The processing shifts to the step S31, and the aggregation point identifying unit 101 determines whether or not there is an unprocessed component item in the system configuration data storage unit 210 (step S31). When there is an unprocessed component item, the processing returns to the step S21. On the other hand, when there is no unprocessed component item, the processing returns to the calling-source processing.

When this processing is performed, the list of the aggregation points is stored in the aggregation point storage unit 102.

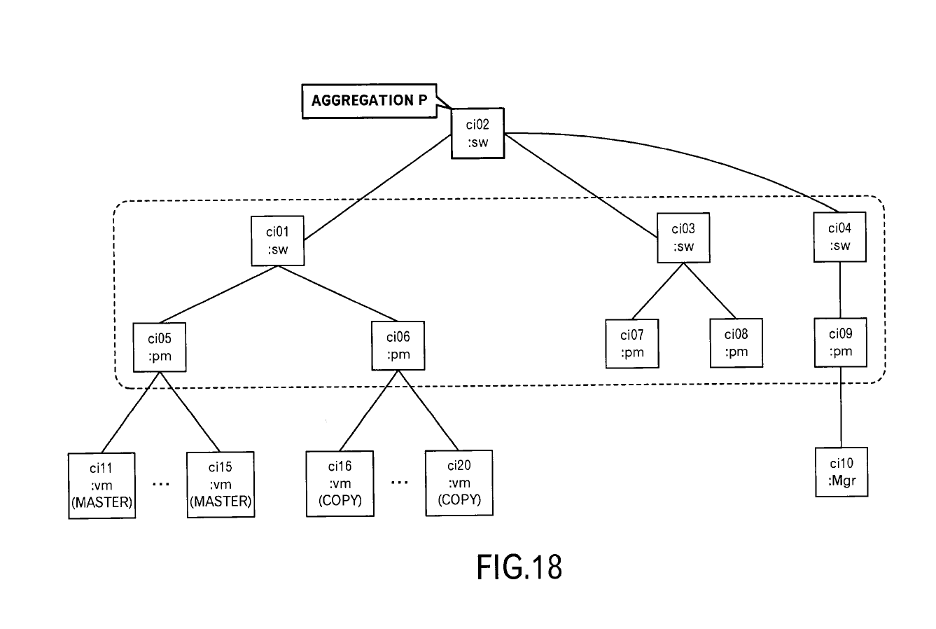

Returning to the explanation of the processing in FIG. 9, next the failure part candidate extractor 103 performs a processing for extracting a failure part candidate (step S3). This processing for extracting the failure part candidate will be explained by using FIGS. 17 to 20. The failure part candidate extractor 103 identifies one unprocessed aggregation point in the aggregation point storage unit 102 (FIG. 17: step S41). Then, the failure part candidate extractor 103 searches the system configuration data storage unit 210 for component items that are arranged within n hops from the identified aggregation point (step S43). For example, in case of the structural aggregation point, the component items that are connected through the connection relationship within n hops (e.g. within 2 hops) are extracted as the failure part candidates. In the example of FIG. 10, the switch ci02 is identified as the aggregation point, therefore, as illustrated in FIG. 18, the switches ci01, ci03 and ci04 and the physical machines ci05 to ci09, which are surrounded by a dotted line, are extracted as component items that are connected within 2 hops through the connection relationship from the switch ci02 that is the aggregation point.

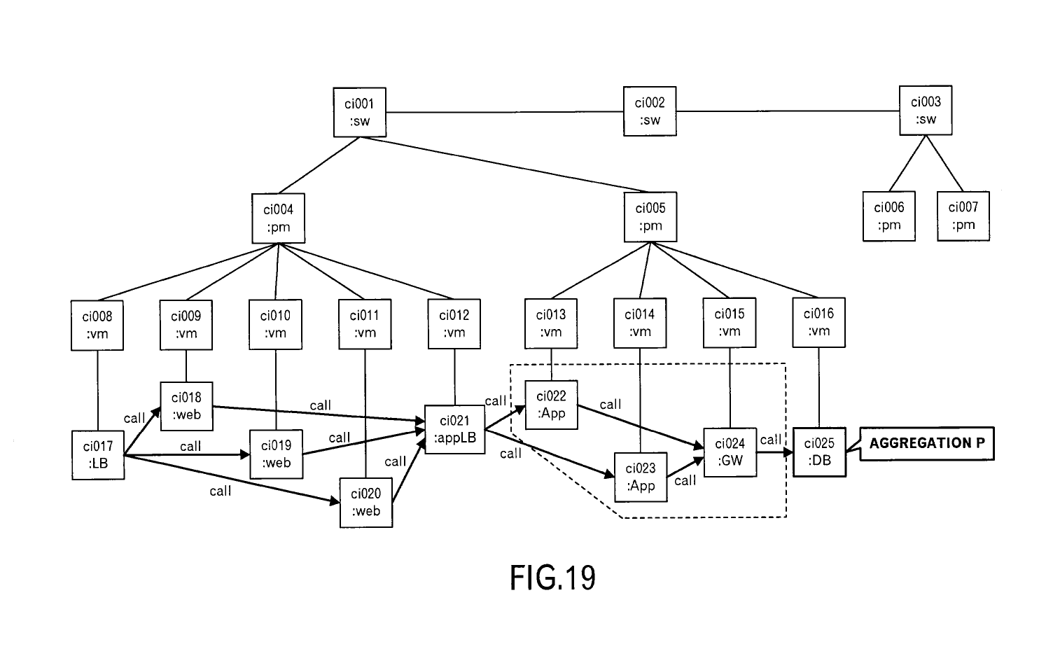

On the other hand, when the aggregation point for the behavior is identified based on the number of items that directly or indirectly call the item to be processed in the system as illustrated in FIG. 15, component items that are traced through the calling relationship within n hops (e.g. within 2 hops) from the DB server ci025 that is the aggregation point are extracted. More specifically, the application servers ci022 and ci023 and the gateway ci024, which are surrounded by a dotted line in FIG. 19, are extracted.

When the aggregation point is extracted after totally evaluating the number of subordinate items and the number of items that directly or indirectly call the item to be processed, or when there is an aggregation point that satisfies both of the criterion for the number of subordinate items and the criterion for the number of items that directly or indirectly call the item to be processed, both of the component items that are connected within the predetermined number of hops through the connection relationship and the component items that are connected within the predetermined number of hops through the calling relationship are extracted.

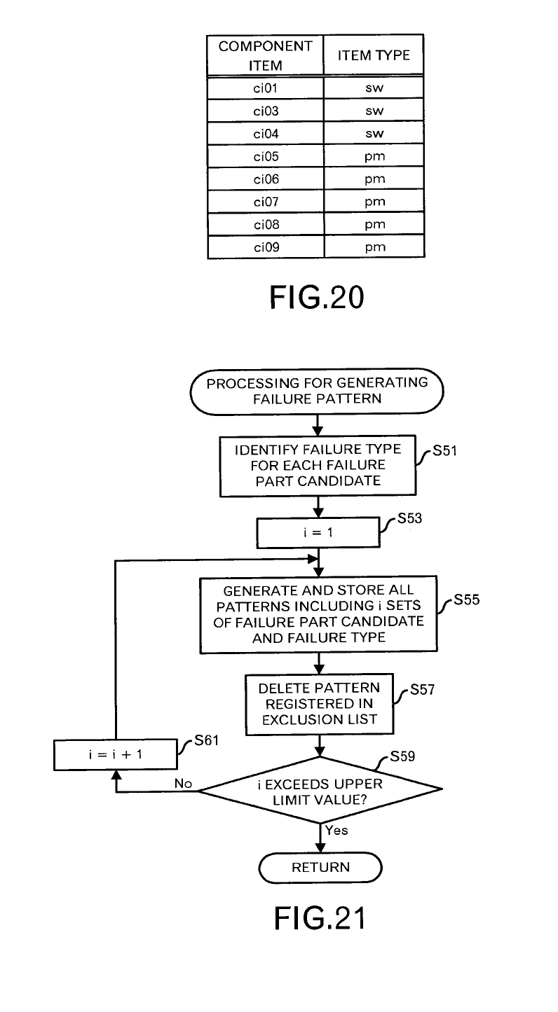

After that, the failure part candidate extractor 103 stores the component items detected at the search of the step S43 as the failure part candidate into the failure part candidate list storage unit 104 (step S45). In the example of FIG. 18, data as illustrated in FIG. 20 is stored in the failure part candidate list storage unit 104, for example. In an example of FIG. 20, an identifier of a component item is stored in association with an item type of the component item.

Then, the failure part candidate extractor 103 determines whether or not there is an unprocessed aggregation point in the aggregation point storage unit 102 (step S47). When there is an unprocessed aggregation point, the processing returns to the step S41. On the other hand, when there is no unprocessed aggregation point, the processing returns to the calling-source processing.

By performing such a processing, the component items that have high possibility that the aggregation point is influenced when the failure occurs are extracted as the failure part candidates.

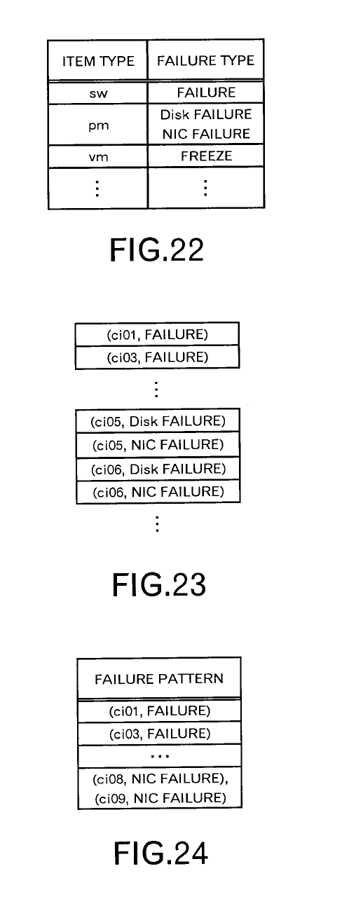

Returning to the explanation of the processing in FIG. 9, the failure pattern generator 105 performs a processing for generating a failure pattern (step S5). This processing for generating the failure pattern will be explained by using FIGS. 21 to 24. Firstly, the failure pattern generator 105 identifies, in the failure part candidate list storage unit 104, a failure type that corresponds to an item type of each failure part candidate, from the failure type list storage unit 106 (FIG. 21: step S51). Data as illustrated in FIG. 22 is stored in the failure type list storage unit 106, for example. In an example of FIG. 22, for each item type, one or plural failure type are correlated. For example, two failure types, in other words, Disk failure and Network Interface Card (NIC) failure, are associated with the item type “physical machine pm”. Even in case of the same component item, when the failure type is different, the spread situation of the influence is different. Therefore, the different treatments are performed distinctively.

Then, the failure pattern generator 105 initializes a counter i to “1” (step S53). After that, the failure pattern generator 105 generates all of patterns, which includes “i” sets of the failure part candidate and the failure type, and stores the generated patterns into the failure pattern list storage unit 108 (step S55).

When the failure part candidates as illustrated in FIG. 20 are extracted, one failure type “failure” is obtained when the item type is “sw”, and two failure types “Disk failure” and “NIC failure” are obtained when the item type is “pm”, from data of the list of failure types as illustrated in FIG. 22. Therefore, as illustrated in FIG. 23, in case of the switch, one set of the identifier of the component item and the failure type “failure” is generated for each switch, and in case of the physical machine, two sets, in other words, a set of the identifier of the component item and the failure type “Disk failure” and a set of the identifier of the component item and the failure type “NIC failure”, are generated for each physical machine. As for the failure pattern including one set of these sets, it is assumed that one failure occurs at one part. That failure pattern is stored in the failure pattern list storage unit 108.

Moreover, it may be assumed that the failures occur at plural failure part candidates at once. For example, in case of i=2, a failure pattern including two sets of the aforementioned sets is generated for all combinations of the aforementioned sets. For example, a combination of a set (ci01, failure) and a set (ci03, failure), a combination of the set (ci01, failure) and a set (ci06, Disk failure) and the like are generated.

Then, the failure patterns generated at the step S55 are stored in the failure pattern list storage unit 108. Data as illustrated in FIG. 24 is stored in the failure pattern list storage unit 108, for example. In an example of FIG. 24, a list of the failure patterns is stored.

After that, the failure pattern generator 105 deletes the failure pattern stored in the exclusion list storage unit 107 from the failure pattern list storage unit 108 (step S57). A failure pattern that is not required to consider in case of only one failure, and a combination that does not occur and/or is not required to consider in case where the failures occur at plural parts are registered in advance in the exclusion list. This registration may beperformedinadvancebytheoperationadministratorbyusinghisorherknowledge. Moreover, the virtual machines under a physical machine are also failed, when the physical machine is failed. Therefore, when a set (pm1, failure) is registered, a rule that a combination of (pm1, failure) and (vm11, failure) are deleted may be registered and applied.

For example, by using a technique described, for example, in Japanese Laid-open Patent Publication No. 2011-145773 (US 2011/0173500 A1), the failure patterns (or rule) to be registered in the exclusion list may be automatically generated from the system configuration data storage unit 210, and may be stored in the exclusion list storage unit 107.

After that, the failure pattern generator 105 determines whether or not “i” exceeds an upper limit value (step S59). The upper limit value is an upper limit of the failures that occur at once, and is preset. Then, when “i” does not exceed the upper limit value, the failure pattern generator 105 increments “i” by 1 (step S61), and the processing returns to the step S55. On the other hand, when “i” exceeds the upper limit value, the processing returns to the calling-source processing.

By performing such a processing, the failure patterns that influence the aggregation point and are to be assumed are generated.

Returning to the explanation of the processing in FIG. 9, the simulator 109 performs, for each failure pattern stored in the failure pattern list storage unit 108, simulation of the state transition of each component item, which is stored in the system configuration data storage unit 210, according to the state transition model stored in the state transition model storage unit 110, by assuming the failure occurs according to the failure pattern (step S7).

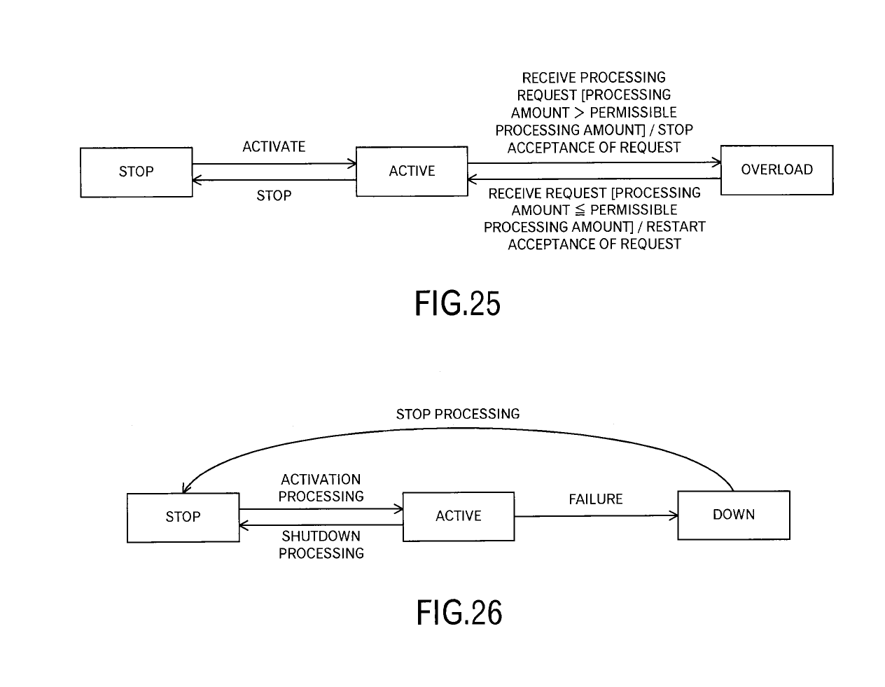

The state transition model is stored in advance for each item type in the state transition model storage unit 110. Typically, the state transition model is described in a format as illustrated in FIG. 25. The state represents the state of the component item, and is represented by a circle or square that surrounds the state name. The transition between the states represents a change from a certain state to another state, and is represented by an arrow. A trigger, guard condition and effect are defined for the transition. The trigger is an event that causes the transition, the guard condition is a condition for making the transition, and the effect represents the behavior with the transition. The guard condition and effect may not be defined. In this embodiment, the transition is represented in a format “transition: trigger [guard condition]/effect”. In FIG. 25, the transition from the state “stop” to the state “active” occurs upon the trigger “activate”, and the transition from the state “active” to the state “stop” occurs upon the trigger “stop”. Moreover, the transition from the state “active” to the state “overload” occurs when the guard condition [processing amount> permissible processing amount] is satisfied in response to the trigger “receive a processing request”. As that effect, “stop acceptance of request” is performed. On the other hand, the transition from the state “overload” to the state “active” occurs when the guard condition [processing amount 5 permissible processing amount] is satisfied in response to the trigger “receive a request”. As that effect, “restart acceptance of request” is performed. In this embodiment, the states and/or effects of other component items can be expressed as the trigger. For example, as the trigger from the state “active” to the state “stop”, a notation “shutdown@pm” can be used. For example, in the state transition model of the virtual machine vm, it is expressed “when pm is stopped, the state of vm shifts from the state “active” to the state “stop””.

More specifically, an example of the state transition model for the component item that has the item type “sw” and is used in the system illustrated in FIG. 10 will be depicted in FIG. 26. As illustrated in FIG. 26, the state transition model includes the state “stop”, the state “active” and the state “down”. Then, the transition from the state “stop” to the state “active” is performed in response to the trigger “activation processing”. Moreover, the transition from the state “active” to the state “down” is performed in response to the trigger “failure”. The transition from the state “active” to the state “stop” is performed in response to the trigger “shutdown processing”. Furthermore, the transition from the state “down” to the state “stop” is performed in response to the trigger “stop processing”. Thus, when the switch is failed, the switch becomes down.

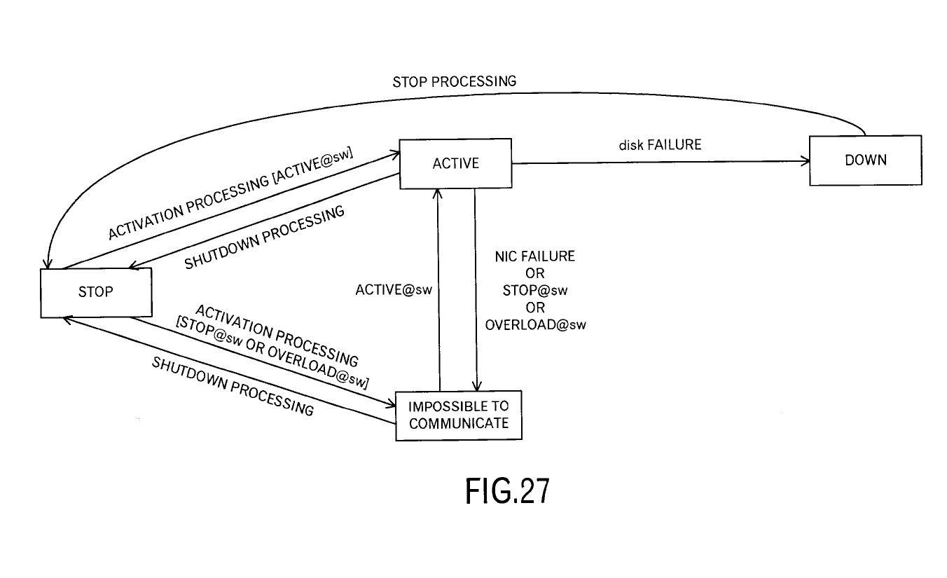

Moreover, an example of the state transition model for the component item that has the item type “pm” and is used in the system illustrated in FIG. 10 will be depicted in FIG. 27. As illustrated in FIG. 27, the state transition model includes the state “stop”, the state “active”, the state “impossible to communicate” and the state “down”. The transition from the state “stop” to the state “active” is performed when the trigger “activation processing” is performed and the guard condition [sw is active] is satisfied. The transition from the state “active” to the state “down” is performed in response to the trigger “disk failure”. Moreover, the transition from the state “active” to the state “impossible to communicate” is performed in response to the trigger “NIC failure”, “stop of sw” or “overload of sw”. On the other hand, the transition from the state “impossible to communicate” to the state “active” is performed in response to the trigger “sw is active”. The transition from the state “active” to the state “stop” is performed in response to the trigger “shutdown processing”. Furthermore, the transition from the state “stop” to the state “impossible to communicate” is performed when the trigger “activation processing” is performed and the guard condition [sw is stopped] or [sw is overloaded] is satisfied. Inversely, the transition from the state “impossible to communicate” to the state “stop” is performed in response to the trigger “shutdown processing”. Moreover, the transition from the state “down” to the state “stop” is performed in response to the trigger “stop processing”. Thus, the state shifts from “active” to “impossible to communicate” in accordance with the state of sw and/or NIC failure, and the state shifts from “impossible to communicate” to “active” when the state of sw is recovered. In addition, when the disk failure occurs, the state shifts from “active” to “down”.

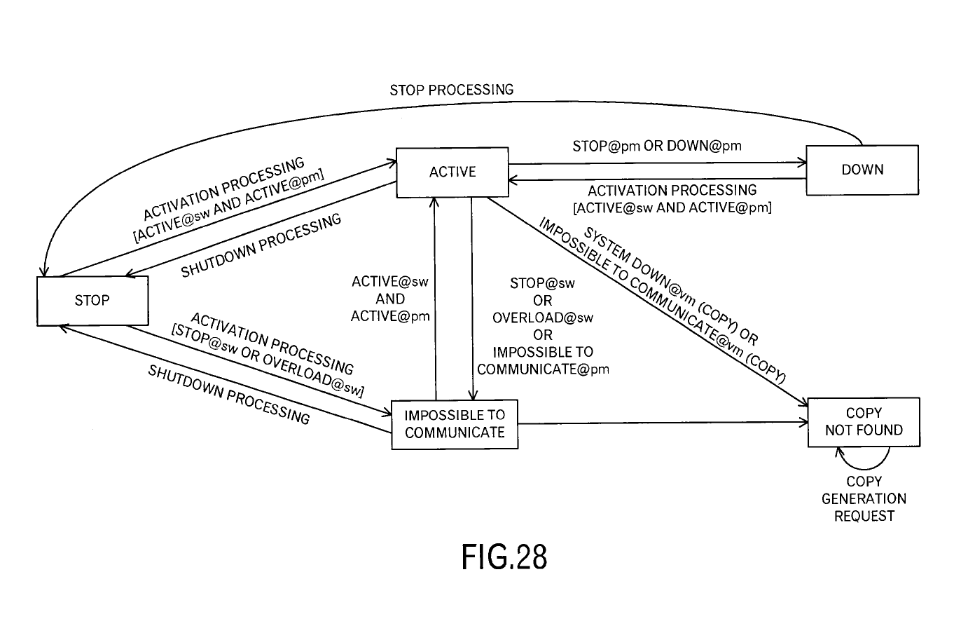

Moreover, an example of the state transition model in case of a main virtual machine that has the item type “vm” and is used in the system illustrated in FIG. 10 will be explained by using FIG. 28. As illustrated in FIG. 28, the state transition model includes the state “stop”, the state “active”, the state “down” and the state “copy not found”. The transition from the state “stop” to the state “active” is performed when the trigger “activation processing” is performed and the guard condition [sw is active and pm is active] is satisfied. Moreover, the transition from the state “active” to the state “down” is performed in response to the trigger “pm is stopped” or “pm is down”. The transition from the state “down” to the state “active” is performed when the trigger “activation processing” is performed and the guard condition [sw is active and pm is active] is satisfied. The transition from the state “active” to the state “impossible to communicate” is performed in response to the trigger “sw is stopped”, “sw is overloaded” or “pm is impossible to communicate”. The transition from the state “impossible to communicate” to the state “active” is performed in response to the trigger “sw is active and pm is active”. Furthermore, the transition from the state “active” to the state “copy not found” is performed in response to the trigger “vm(copy) is down” or “vm(copy) is impossible to communicate”. The self transition to the state “copy not found” is performed in response to the trigger “copy generation request”. The transition from the state “impossible to communicate” to the state “copy not found” is automatically performed. The transition from the state “active” to the state “stop” and the transition from the state “impossible to communicate” to the state “stop” are performed in response to the trigger “shutdown processing”. Moreover, the transition from the state “stop” to the state “impossible to communicate” is performed when the trigger “activation processing” is performed and the guard condition [sw is stopped or sw is overloaded] is satisfied. The transition from the state “down” to the state “stop” is performed in response to the trigger “stop processing”. Thus, the trigger or guard condition for the transition partially includes the state of the physical machine pm. Moreover, the existence of the copy (vm(copy)) of itself is always checked, and when the existence becomes unknown, the copy generation request is transmitted to the manager Mgr. When its own state is the state “impossible to communicate”, the state is automatically shifted to the state “copy not found”.

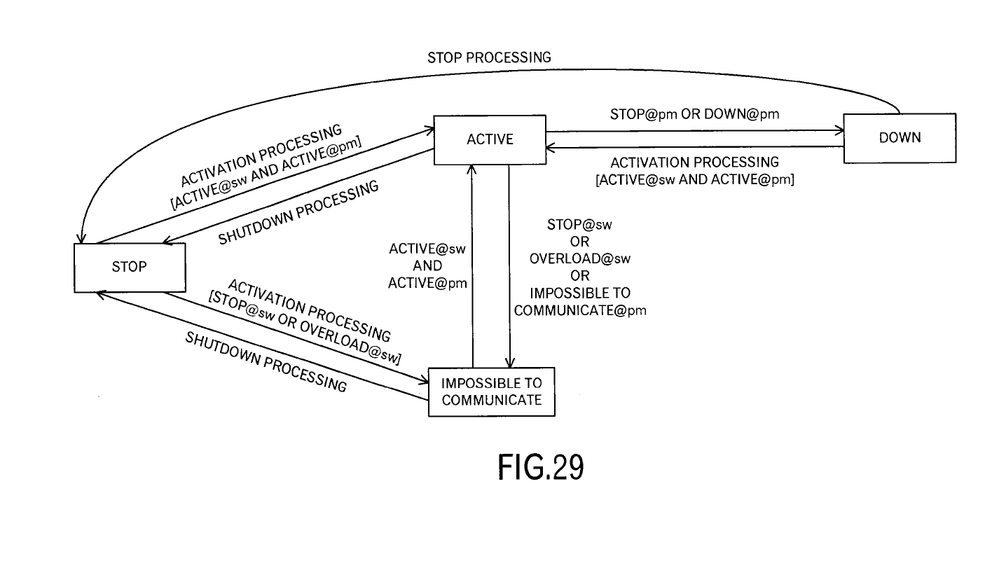

Furthermore, an example of the state transition model in case of the copy virtual machine that has the item type “vm” and is used in the system illustrated in FIG. 10 will be depicted in FIG. 29. The difference with the main virtual machine is that the state transition model does not include the state “copy not found” and the transitions associated with this state do not also exist, and portions other than that is similar.

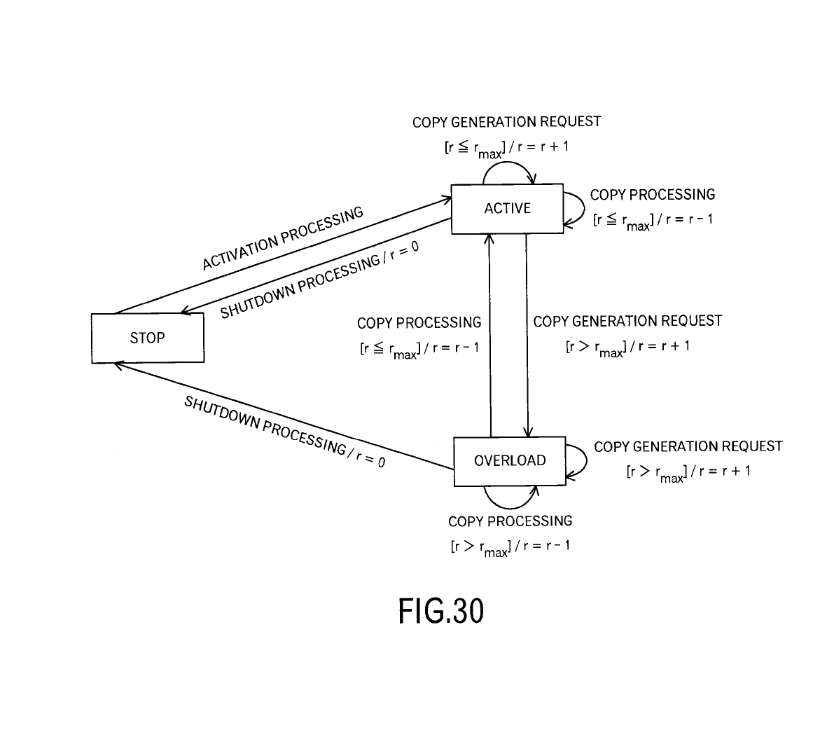

Moreover, an example of the state transition model for the component item that is used in the system illustrated in FIG. 10 and has the item type “Mgr” will be illustrated in FIG. 30. As illustrated in FIG. 30, the state transition model includes the state “stop”, the state “active” and the state “overload”. Then, the transition from the state “stop” to the state “active” is performed in response to the trigger “activation processing”. The first self transition of the state “active” is performed when the trigger “copy generation request” is performed and the guard condition [request amount r is equal to or less than rₘₐₓ] is satisfied. When this transition is performed, the request amount r is incremented by 1. Moreover, the second self transition of the state “active” is performed when the trigger “copy processing” is performed and the guard condition [request amount r is equal to or less than rₘₐₓ] is satisfied. When this transition is performed, the request amount r is decremented by 1. Moreover, the transition from the state “active” to the state “overload” is performed when the trigger “copy generation request” and the guard condition [r>rₘₐₓ] is satisfied. The first self transition of the state “overload” is performed when the trigger “copy generation request” is performed and the guard condition [r>rₘₐₓ] is satisfied. When this transition is performed, the request amount r is incremented by 1. Moreover, the second self transition of the state “overload” is performed when the trigger “copy processing” is performed and the guard condition [r>rₘₐₓ] is satisfied. When this transition is performed, the request amount r is decremented by 1. The transition from the state “overload” to the state “active” is performed when the trigger “copy processing” is performed and the guard condition [r is equal to or less than rₘₐₓ] is satisfied. When this transition is performed, the request amount r is decremented by 1. The transition from the state “active” to the state “stop” and the transition from the state “overload” to the state “stop” are performed in response to the trigger “shutdown processing”. In response to this transition, the request amount r becomes “0”.

The simulator 109 performs the simulation by using those state transition models. The simulation is performed assuming that the specific failure occurs in the specific component item, which is defined in the failure pattern, at this time.

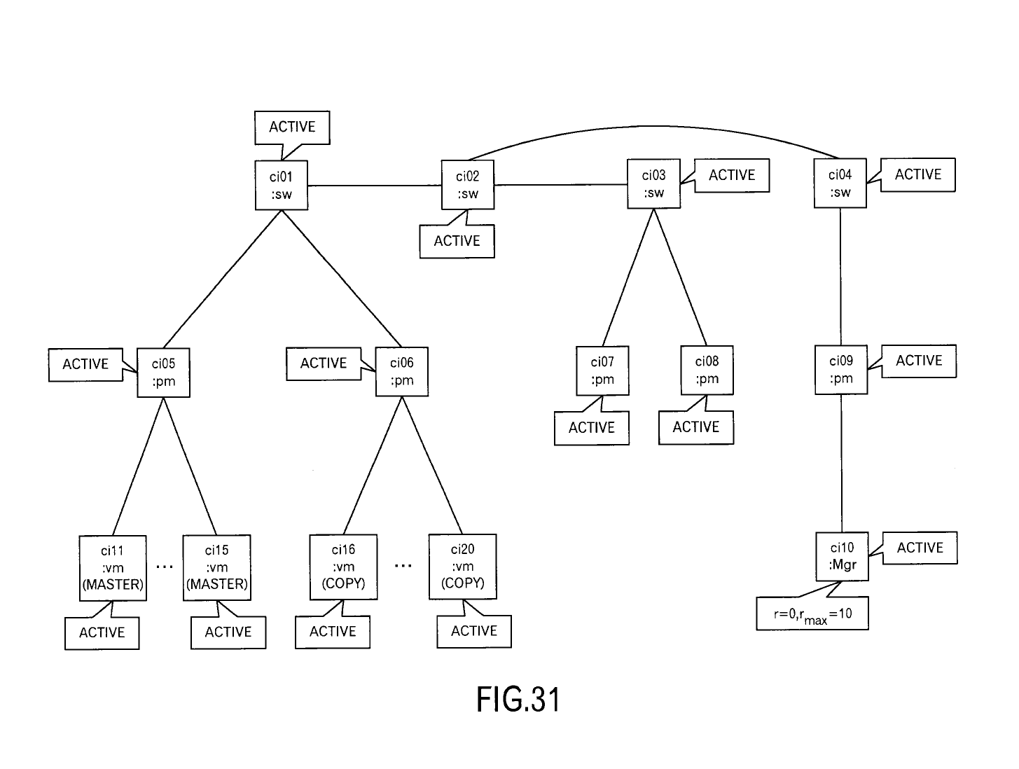

For example, as for the system in FIG. 10, when the simulation is performed for the failure pattern (ci06, NIC failure), a specific state transition will be explained using FIGS. 31 to 36. Here, the main virtual machine vm transmits a copy generation request in the state “copy not found” once per one step, repeatedly. Moreover, it is assumed that the maximum request amount rₘₐₓ in the manager Mgr is 10. Furthermore, the manager Mgr also can process one request per one step. In addition, in order to identify the failure that influences at the early stage, the simulation is completed after five steps, for example.

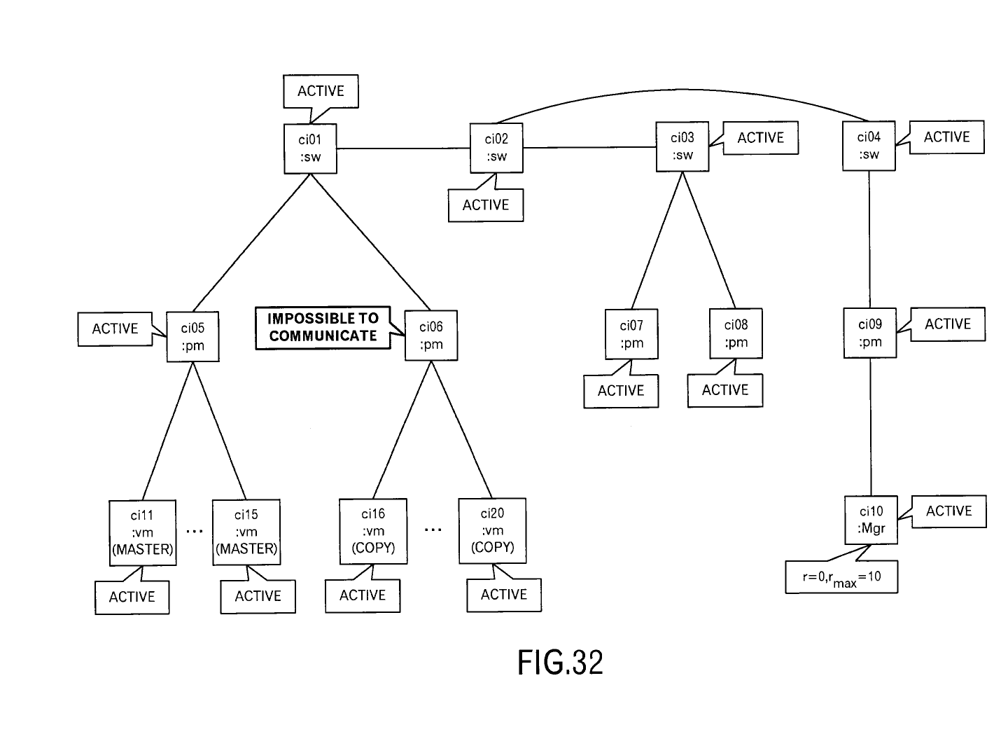

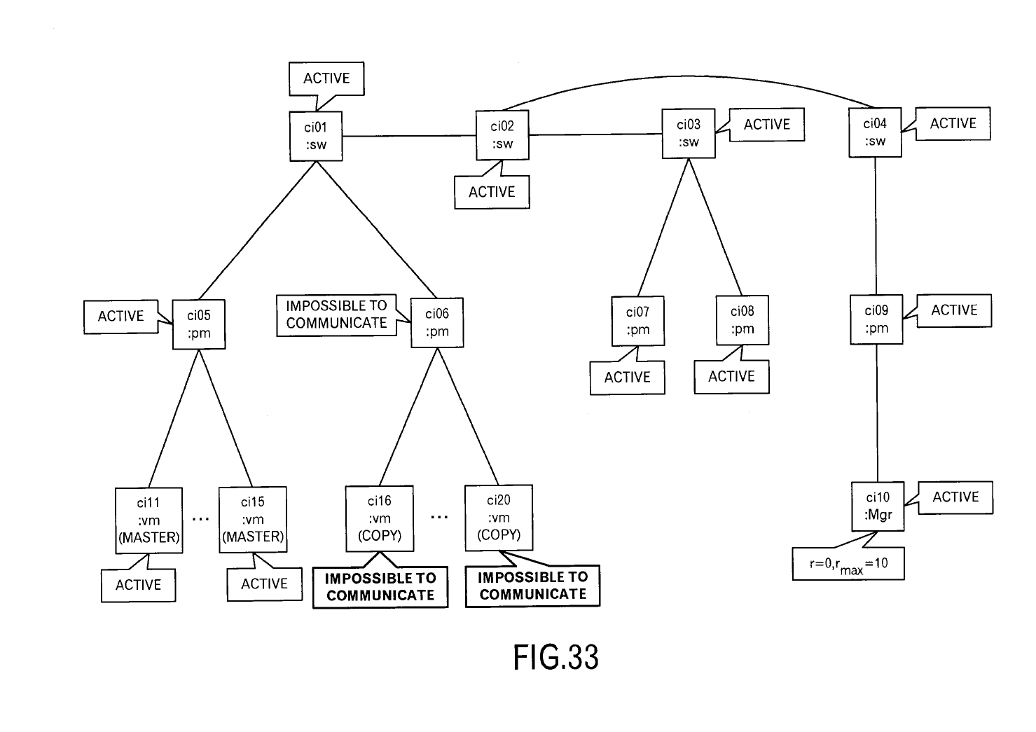

In the initial state, as illustrated in FIG. 31, all component items are “active”, and the request amount r in the manager Mgr is “0”. Then, at the first step, as illustrated in FIG. 32, it is assumed that the state of the component item ci06 that is the physical machine becomes the state “impossible to communicate” in response to the NIC failure. Then, at the second step, as illustrated in FIG. 33, the states of the component items ci16 to ci20 that are the copy virtual machines shift to the states “impossible to communicate”.

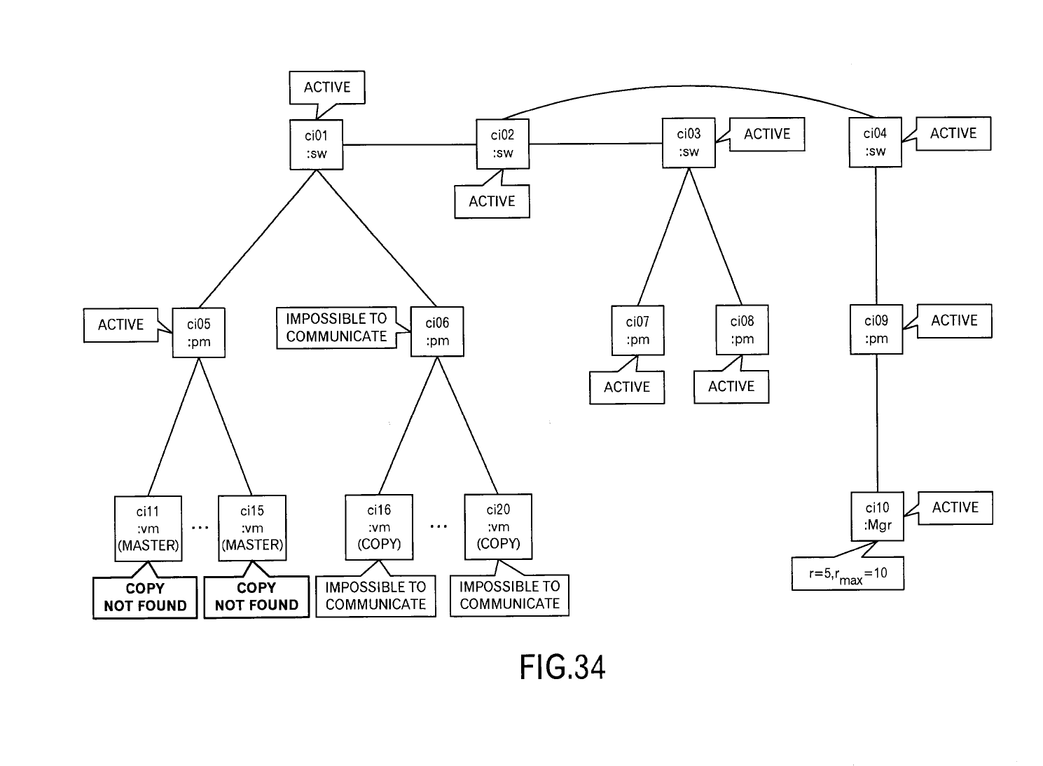

After that, at the third step, as illustrated in FIG. 34, the states of the component items ci11 to ci15 that are the main virtual machines shift to the states “copy not found”, because the existence of the virtual machine that is a copy could not be checked. Then, the copy generation request is transmitted from the component items ci11 to ci15 that are the main virtual machines to the manager Mgr. Therefore, because total 5 copy generation requests reach the manager Mgr, the request amount r increases to “5”.

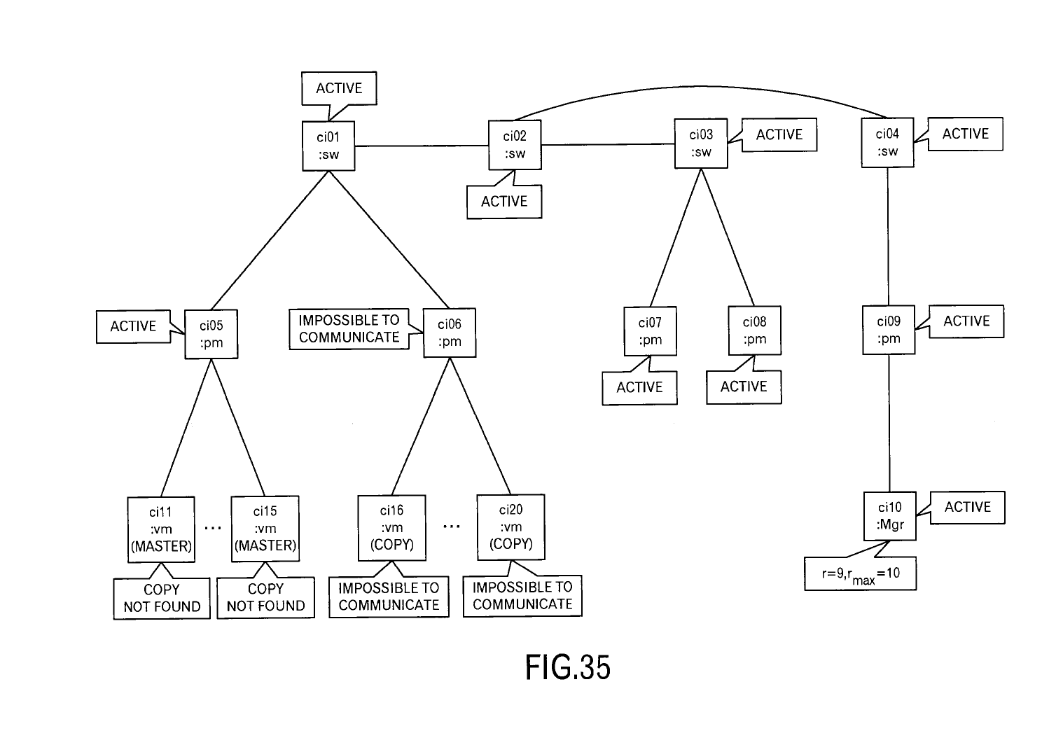

Then, at the fourth step, as illustrated in FIG. 35, the manager Mgr processes one copy generation request, however, the component items ci11 to ci15 that are the main virtual machines cannot check the existence. Therefore, the component items ci11 to ci15 transmit the copy generation request to the manager Mgr again, and r becomes 9=5−1+5.

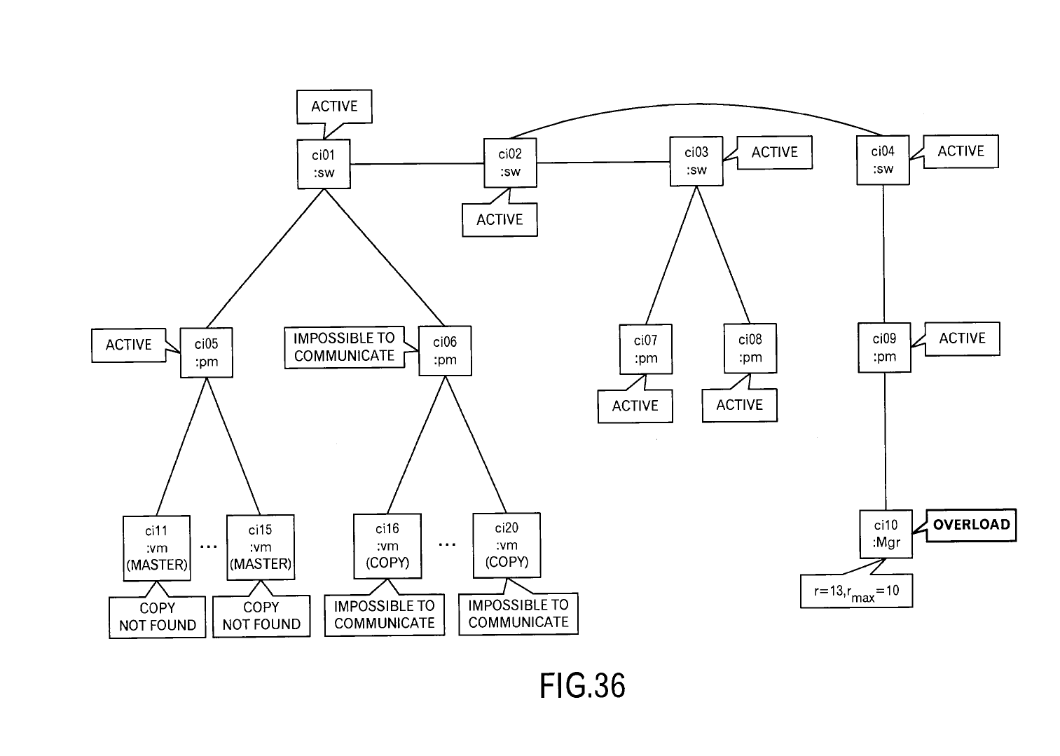

After that, at the fifth step, as illustrated in FIG. 36, the manager Mgr processes one copy generation request, however, the component items ci11 to ci15 that are the main virtual machines cannot check the existence. Therefore, the component items ci11 to ci15 transmits the copy generation request to the manager Mgr again, and r becomes 13=9−1+5. Accordingly, because the request amount r exceeds the maximum processing amount rₘₐₓ=10 of the manager Mgr, the state of the component item ci10 that is the manager Mgr shifts to the state “overload”.

As described above, it is understood that any trouble occurs in the component items ci10 to ci20 in addition to the component item ci06 that is included in the failure pattern. Here, the number of damaged items including the component item included in the failure pattern is counted. In this example, the number of damaged items “12” is obtained.

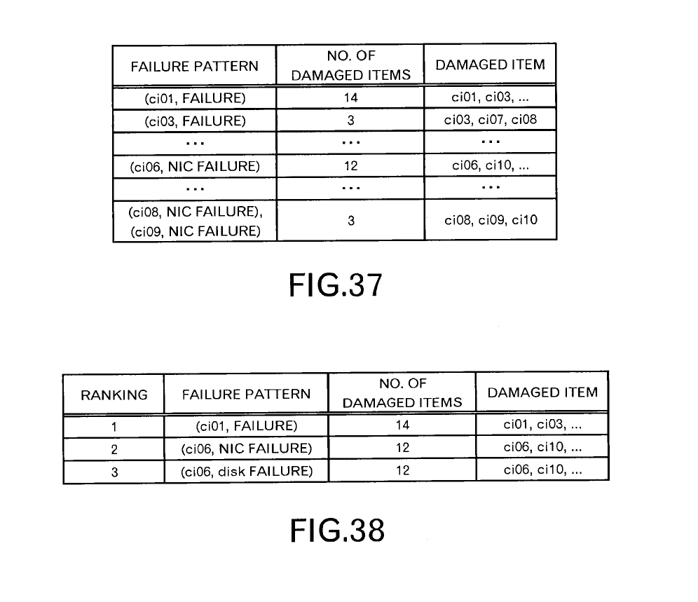

When the aforementioned processing is performed for each failure pattern, the simulator 109 stores data as illustrated in FIG. 37 into the simulation result storage unit 111. In an example of FIG. 37, for each failure pattern, the number of damaged items that is the number of component items that are influenced and identifiers of the damaged items that are influenced are included.

As for the specific processing method of this simulation, a conventional method can be used, and the method of the simulation itself is not the main portion of this invention, therefore the explanation of the specific method is omitted.

Returning to the explanation of the processing in FIG. 9, the output processing unit 112 sorts the failure patterns in descending order of the number of damaged items, which is included in the simulation result stored in the simulation result storage unit 111 (step S9). Then, the output processing unit 112 extracts the top predetermined number of failure patterns from the sorting result, and outputs data of the top predetermined number of failure patterns, which were extracted, to the user terminal 300, for example (step S11).

For example, data as illustrated in FIG. 38 is generated and displayed on a display device of the user terminal 300. In an example of FIG. 38, the top predetermined number is “3”, and for each failure pattern, the number of damaged items and damaged items are represented.

Because the failure patterns whose number of damaged items is great, in other words, the failure patterns whose range of the influence is broad can be identified, it becomes possible to perform the countermeasure against these failure patterns.

### Embodiment 2

In the first embodiment, an example was explained that the component items included in the fixed range of the number of hops n from the aggregation point are extracted as the failure part candidates. However, “n” cannot be always set appropriately from the first time. Moreover, the influence range of the component item that is relatively apart from the aggregation point may be broad. Therefore, by performing a processing that will be explained later, the range from which the failure part candidates are extracted is dynamically changed to extract the proper failure part candidates. Accordingly, the failure pattern to be treated is appropriately extracted.

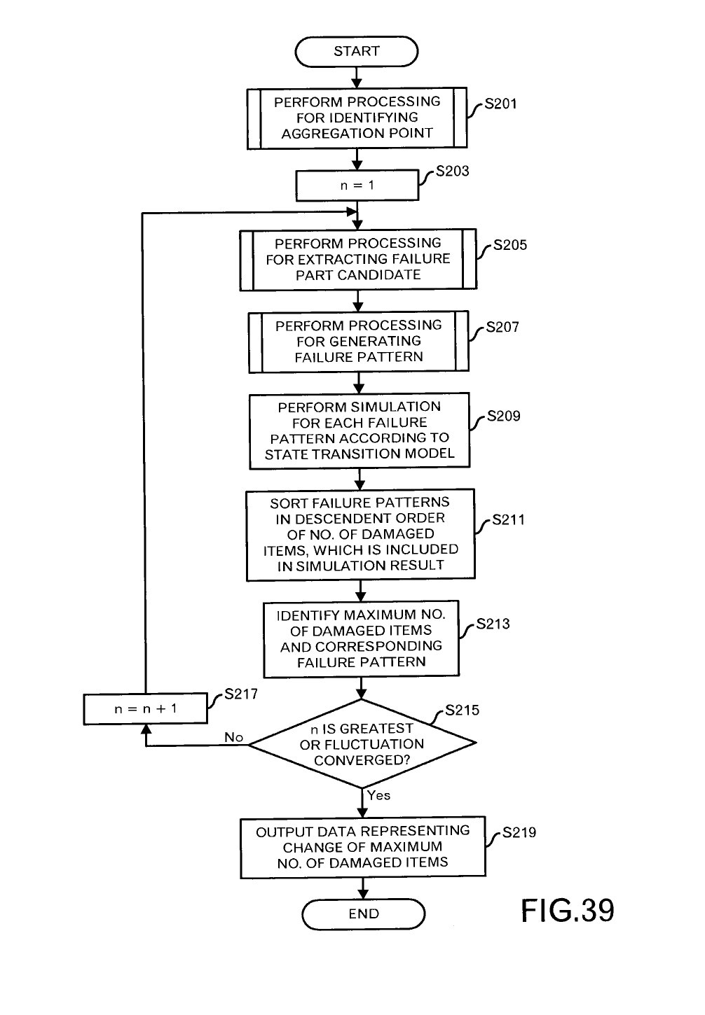

For example, a processing as illustrated in FIG. 39 is performed. Firstly, the aggregation point identifying unit 101 performs the processing for identifying the aggregation point (FIG. 39: step S201). This processing for identifying the aggregation point is the same as the processing explained by using FIGS. 10 to 16. Therefore, the detailed explanation is omitted. Next, the failure part candidate extractor 103 initializes the counter n to “1” (step S203). Then, the failure part candidate extractor 103 performs the processing for extracting the failure part candidate (step S205). This processing for extracting the failure part candidate is the same as the processing explained by using FIGS. 17 to 20. Therefore, the detailed explanation is omitted. After that, the failure pattern generator 105 performs the processing for generating the failure pattern (step S207). The processing for generating the failure pattern is the same as the processing explained by using FIGS. 21 to 24. Therefore, the detailed explanation is omitted.

Then, the simulator 109 performs, for each failure pattern stored in the failure pattern list storage unit 108, the simulation of the state transition of each component item, which is stored in the system configuration data storage unit 210, according to the state transition model stored in the state transition model storage unit 110, while assuming that the failure of the failure pattern occurs (step S209). The processing contents of this step is similar to the step S7, therefore, the detailed explanation is omitted.

After that, the output processing unit 112 sorts the failure patterns in descending order of the number of damaged items, which is included in the simulation result (step S211). This step is also similar to the step S9, therefore, the further explanation is omitted. Then, the output processing unit 112 identifies the maximum number of damaged items and the corresponding failure pattern at that time, and stores the identified data, for example, into the simulation result storage unit 111 (step S213).

Furthermore, the output processing unit 112 determines whether or not n reached the maximum value, which was preset, or the fluctuation converged (step S215). As for the convergence of the fluctuation, it is determined whether or not a condition such as a condition that the maximum number of damaged items does not sequentially change two times is satisfied.

When n does not reach the maximum value or the fluctuation does not converge, the output processing unit 112 increments n by 1 (step S217). Then, the processing returns to the step S205.

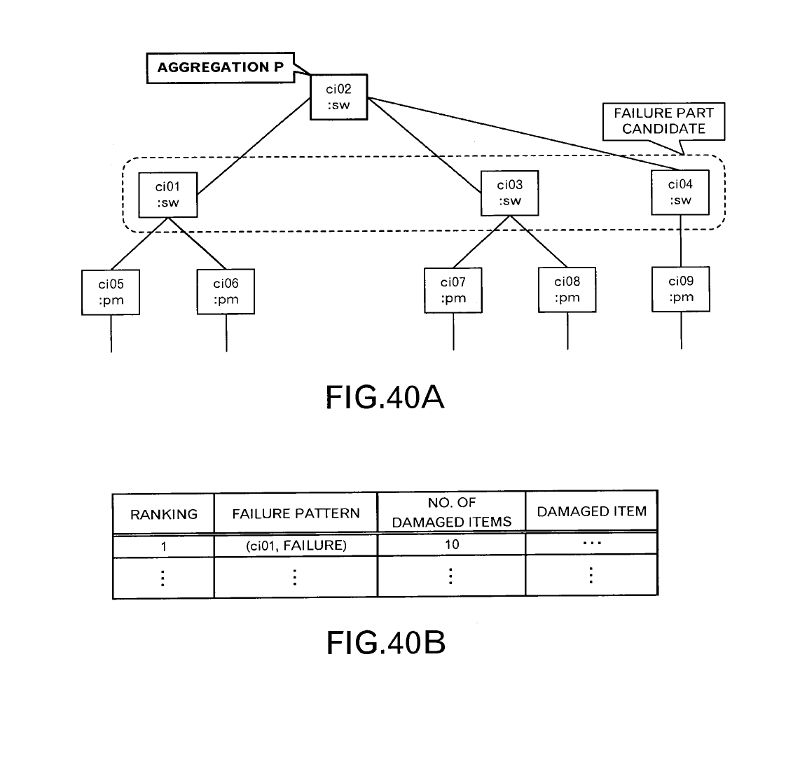

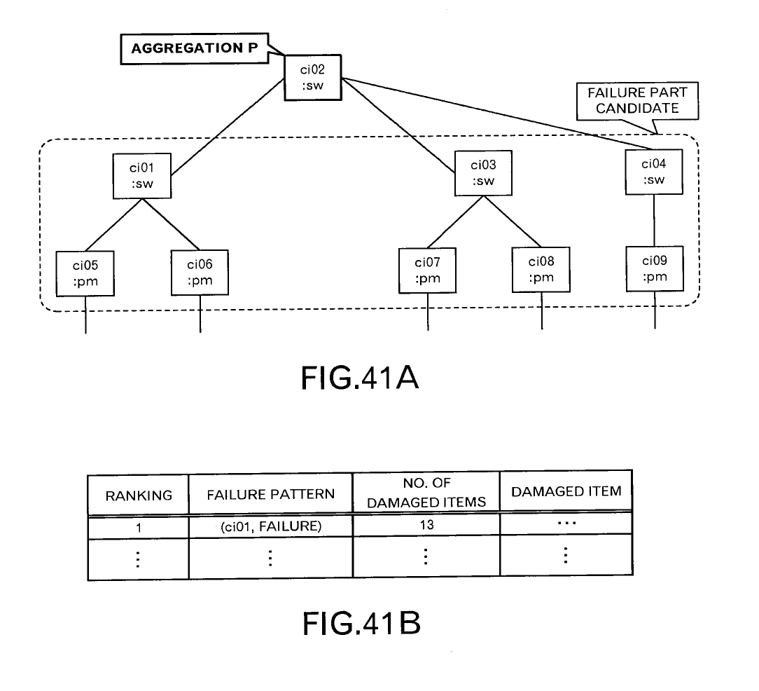

As schematically illustrated in FIG. 40A, when it is assumed that the component item ci02 within the system is the aggregation point, the simulation result as illustrated in FIG. 40B is obtained when extracting the failure part candidates for the number of hops n=1. In this example, in case of n=1, the maximum number of damaged items is 10. Furthermore, as schematically illustrated in FIG. 41A, the simulation result as illustrated in FIG. 41B is obtained, when extracting the failure part candidates for the number of hops n=2. In this example, in case of n=2, the maximum number of damaged items is 13. Such a processing is repeated until the condition of the step S215 is satisfied.

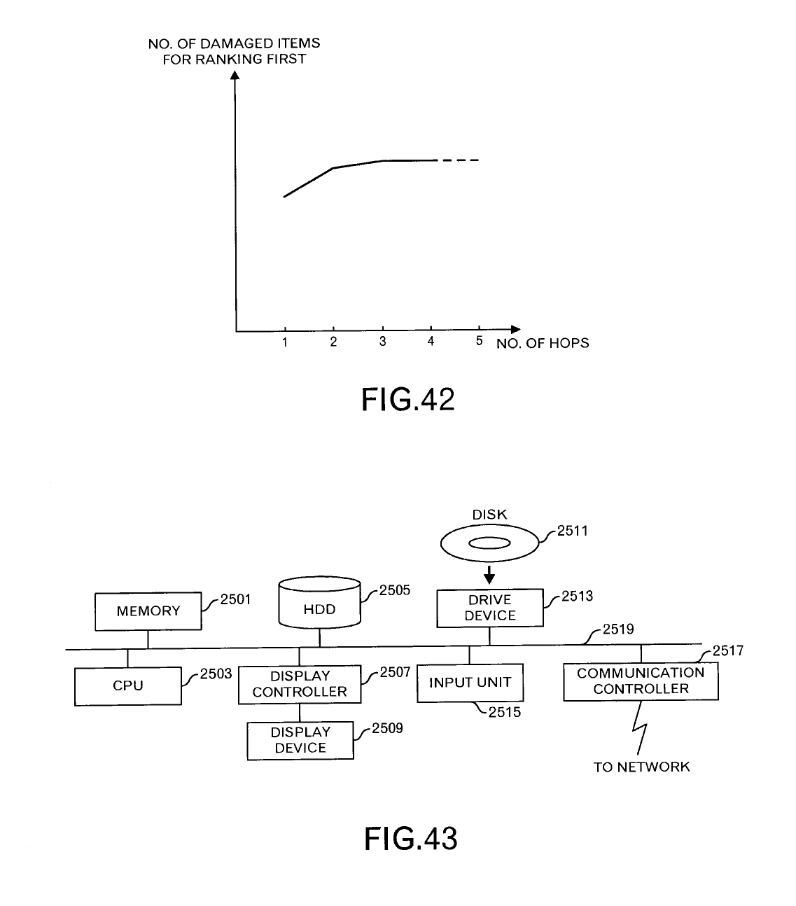

On the other hand, when n reached the maximum value or the fluctuation converged, the output processing unit 112 generates data representing the change of the maximum number of damaged items, and outputs the generated data to the user terminal 300, for example (step S219). The user terminal 300 displays data as illustrated in FIG. 42, for example. In FIG. 42, the horizontal axis represents the number of hops n, and the vertical axis represents the number of damaged items. In this example, in case of the number of hops n=3 and n=4, the maximum number of damaged items does not change, therefore, the processing for n=5 and more is omitted. However, data as illustrated in FIG. 40B and/or FIG. 41B may be presented.

By carrying out such a processing, it is possible to obtain an estimation as to how broad range from the aggregation point the user should consider. Furthermore, similarly to the first embodiment, it is possible to identify the failure pattern to which attention should be paid, therefore, it is also possible to prepare the countermeasure for that.

As described above, by limiting the failure patterns to failure patterns that have high possibility that the influence range becomes large, it is possible to grasp the failure pattern that has a high risk, efficiently. Especially, even when there are a lot of component items, it is much effective to employ the method in the embodiments, because the embodiments do not depend on the number of component items and the number of failure patterns is determined by the number of items included in a predetermined range from the aggregation point.

Furthermore, although an example was explained above that the operation administrator uses this information processing apparatus, it is possible to design the system that does not cause any large-scale trouble, when the aforementioned processing is performed, for example, at the system design. Furthermore, as described above, when the operation administrator uses this information processing apparatus, it is possible to assume the occurrence of the large-scale trouble in advance, and furthermore it is possible to prepare the countermeasure and perform any action to prevent the trouble in advance. Moreover, when the aforementioned processing is performed in advance at the system change, it becomes possible to perform any action to avoid the change that may cause the large-scale trouble.

Although the embodiments of this technique were explained, this technique is not limited to the embodiments. For example, the aforementioned functional block diagram is a mere example, and may not correspond to any actual program module configuration. The data storage mode is also a mere example, and may not always correspond to an actual file configuration.

Furthermore, as for the processing flows, as long as the processing results do not change, the processing turns may be exchanged and parallel execution may be performed.

Furthermore, an example was depicted that the operation management system 200 and the information processing apparatus 100 are different apparatuses, however, they may be integrated. Moreover, the information processing apparatus 100 may be implemented by plural computers. For example, the simulator 109 may be implemented on another computer.

Furthermore, the number of failures that occur at once may be changed.

In addition, the aforementioned information processing apparatus 100 and operation management system 200 are computer devices as illustrated in FIG. 43. That is, a memory 2501 (storage device), a CPU 2503 (processor), a hard disk drive (HDD) 2505, a display controller 2507 connected to a display device 2509, a drive device 2513 for a removable disk 2511, an input unit 2515, and a communication controller 2517 for connection with a network are connected through a bus 2519 as illustrated in FIG. 43. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the application programs systematically cooperate with each other, so that various functions as described above in details are realized.

The aforementioned embodiments are outlined as follows:

An information processing method relating to the embodiments includes: (A) identifying a component item that satisfies a predetermined condition concerning an indicator value for an influenced range within a system, from among a plurality of component items included in the system, by using data regarding the plural component items and relationships among the plural component items, wherein the data is stored in a first data storage unit; (B) extracting component items included in a predetermined range from the identified component item, based on the data stored in the first storage unit; and (C) generating one or plural failure patterns, each of which includes one or plural sets of one component item of the extracted component items and a failure type corresponding to the one component item, by using data that includes, for each component item type, one or plural failure types and is stored in a second data storage unit, and storing the one or plural failure patterns into a third data storage unit.

Thus, failure patterns for all component items within the system are not generated, however, by limiting the component items from which the failure pattern should be generated as described above, it becomes possible to efficiently identify failure patterns that have large influence. When any trouble occurs in the component item to which communication may be concentrated within the system and/or the component item to which messages may be concentrated, large-scale influence is given to the entire system. Therefore, attention is paid to a component item that influences a broad range, however, attention is also paid to the component item that influences that component item by the failure and trouble. Thus, it is possible to generate failure pattern candidates that give an impact to the entire system by influencing the component item that influences a broad range as described above even if its influence range is small.

The aforementioned information processing method may further include: (D) performing simulation for a state of the system for each of the one or plural failure patterns, which are stored in the third data storage unit, to identify, for each of the one or plural failure patterns, the number of component items that are influenced by a failure defined in the failure pattern. By performing the simulation as described above, it is possible to further narrow the failure pattern.

Moreover, the aforementioned information processing method may further include: (E) sorting the one or plural failure patterns in descending order of the identified number of component items; and outputting the top predetermined number of failure patterns among the one or plural failure patterns. Thus, it becomes possible for the user to easily identify the failure pattern to which any action should be taken.

Furthermore, the aforementioned information processing method may further include: repeating the extracting, the generating and the performing by changing the predetermined range; and generating data that represents a relationship between the predetermined range and a maximum value of the numbers of component items, which are identified in the performing. Thus, it becomes possible to determine how to set the predetermined range. In other words, it becomes possible to understand how broad component items that influence the component item that influences a broad range of the component items the user should consider.

Furthermore, the aforementioned relationships among the plural component items may include connection relationships among the plural component items and calling relationships among the plural component items. In such a case, the aforementioned identifying may include: calculating, for each of the plural component items, the number of subordinate items of the component item based on the connection relationships; calculating, for each of the plural component items, the number of items that directly or indirectly call the component item based on the calling relationships; and identifying a component item that satisfies the predetermined condition based on the number of subordinate items and the number of items, which are calculated for each of the plural component items. A threshold may be set for each of the number of subordinate items and the number of items that directly or indirectly call the component item, and any evaluation function may be prepared to totally determine the component item.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable non-transitory storage medium storing a program for causing a computer to execute a process, the process comprising:
identifying a component item that satisfies a predetermined condition concerning an indicator value for an influenced range within a system, from among a plurality of component items included in the system, by using data regarding the plurality of component items and relationships among the plurality of component items;
extracting component items included in a predetermined range from the identified component item, based on the data; and
generating one or plurality of failure patterns, each of which includes one or plural sets of one component item of the extracted component items and a failure type corresponding to the one component item, by using data including, for each component item type, one or plural failure types.

2. The non-transitory computer-readable storage medium as set forth in claim 1, wherein the process comprises:
performing simulation for a state of the system for each of the one or plurality of failure patterns to identify, for each of the one or plurality of failure patterns, the number of component items that are influenced by a failure defined in the failure pattern.

3. The non-transitory computer-readable storage medium as set forth in claim 2, wherein the process comprises:
sorting the one or plurality of failure patterns in descending order of the identified number of component items; and
outputting the top predetermined number of failure patterns among the one or plurality of failure patterns.

4. The non-transitory computer-readable storage medium as set forth in claim 2, wherein the process comprises:
repeating the extracting, the generating and the performing by changing the predetermined range; and
generating data that represents a relationship between the predetermined range and a maximum value of the numbers of component items, which are identified in the performing.

5. The non-transitory computer-readable storage medium as set forth in claim 1, wherein the relationships among the plurality of component items include connection relationships among the plurality of component items and calling relationships among the plurality of component items, and
the identifying comprises:
calculating, for each of the plurality of component items, the number of subordinate items of the component item based on the connection relationships;
calculating, for each of the plurality of component items, the number of items that directly or indirectly call the component item based on the calling relationships; and
identifying a component item that satisfies the predetermined condition based on the number of subordinate items and the number of items, which are calculated for each of the plurality of component items.

6. An information processing method, comprising:
identifying, by using a computer, a component item that satisfies a predetermined condition concerning an indicator value for an influenced range within a system, from among a plurality of component items included in the system, by using data regarding the plurality of component items and relationships among the plurality of component items;
extracting, by using the computer, component items included in a predetermined range from the identified component item, based on the data; and
generating, by using the computer, one or plurality of failure patterns, each of which includes one or plural sets of one component item of the extracted component items and a failure type corresponding to the one component item, by using data including, for each component item type, one or plural failure types.

7. An information processing apparatus, comprising:
a memory; and
a processor configured to use the memory and execute a process, comprising:
identifying a component item that satisfies a predetermined condition concerning an indicator value for an influenced range within a system, from among a plurality of component items included in the system, by using data regarding the plurality of component items and relationships among the plurality of component items;
extracting component items included in a predetermined range from the identified component item, based on the data; and
generating one or plurality of failure patterns, each of which includes one or plural sets of one component item of the extracted component items and a failure type corresponding to the one component item, by using data including, for each component item type, one or plural failure types.
